(19) United States
(12) Patent Application Publication
(10) Pub. No.: US 2010/0192055 A1
(43) Pub. Date: Jul. 29, 2010

(54) APPARATUS, METHOD AND ARTICLE TO INTERACT WITH SOURCE FILES IN NETWORKED ENVIRONMENT

(75) Inventors: Motti Shaked, Vancouver (CA); Michael Weber, Vancouver (CA); Michael Benezra, Vancouver (CA); Assaf Koren, Burnaby (CA)

Correspondence Address: SEED INTELLECTUAL PROPERTY LAW GROUP PLLC, 701 FIFTH AVE, SUITE 5400, SEATTLE, WA, 98104, US

(73) Assignee: KUTANO CORPORATION, Burnaby (CA)

(21) Appl. No.: 12/685,940

(22) Filed: Jan. 12, 2010

Related U.S. Application Data
(60) Provisional application No. 61/147,685, filed on Jan. 27, 2009.

(51) Int. Cl. G06F 15/16; G06F 17/30; G06F 17/00; G06F 3/048

(52) U.S. Cl. 715/234; 707/769; 709/205; 715/760; 707/E17.014

(57) ABSTRACT

A subject of a file's content which is stored on a physical storage medium at a logical address in a networked system may be determined and used to identify the file to facilitate retrieval and/or the provision of information about the file, for example via forums or messages.

### CROSS REFERENCE TO RELATED APPLICATIONS

This application claims benefit under 35 U.S.C. 119(e) of U.S. Provisional Patent Application Ser. No. 61/147,685, filed Jan. 27, 2009 and entitled “APPARATUS, METHOD AND ARTICLE TO INTERACT WITH SOURCE FILES IN NETWORKED ENVIRONMENT,” which is incorporated herein by reference in its entirety.

### BACKGROUND

1. Field

This disclosure generally relates to networked computing environments, and particularly to interacting with files stored on computer-readable media identified via logical addresses.

2. Description of the Related Art

Networked systems are ubiquitous. Such systems allow a variety of devices to communicate. For example, traditional computing networks such as various types of local area networks (LANs) or wide area networks (WANs), allow computing systems to exchange information, for instance files. Such computing networks may include extranets, intranets, or the Internet or Worldwide Web (hereinafter the Web). Traditional telecommunications networks allow what are commonly referred to as telecommunications devices to communicate, such as telephones via wired telephone networks (e.g., POTS) or cellular phones via cellular networks. Increasingly, various types of devices have the ability to communicate over multiple networks or to access information from other types of devices. For instance, cellular phones are often Internet or Web enabled, allowing such cellular phones to communicate via the Internet and or Worldwide Web. Many devices commonly referred to as personal digital assistances (e.g., IPHONE®, TREO®, BLACKBERRY®) are likewise Internet or Web enabled allowing communications via the Internet or Web. Many of these devices may also communicate via other protocols, for instance wirelessly via the IEEE 802.11 protocol or BLUETOOTH® protocol.

Various types of networks may include wired communications channels, wireless communications channels or a combination of wired and wireless communications channels. Networks may be generally open to the public or may limit access to authorized users or accounts. From a practical standpoint, the line between traditional computing networks and traditional telecommunications networks is completely gone.

Many people and businesses increasingly rely on networks to exchange information. One of the most common methods is browsing the Web. Individuals and businesses have populated the Web with millions of Web pages that provide information, entertainment, images, sounds, about a virtually unlimited number of topics. Such Web pages may allow a user to interact with another user, business or other entity. Web pages may, for example, provide information on products and may allow online purchase of the product.

Web pages are typically stored as files on computer-readable media. The Web pages are typically supplied by one or more server computing systems in response to requests by a requesting device or client. The server computing systems typically execute a set of instructions stored on computer-readable media, commonly referred to as server software to receive and respond to requests for files, for instance Web pages. The requesting device or client typically execute a set of instructions stored on computer-readable media to request and handle the files received from the server. Where the client device is requesting Web pages, the set of instructions are commonly referred to as a browser or browser program.

In many instances, two or more logical addresses may point to a single file. For instance, two or more uniform resource locators (URLs) may point to a single Web page. In many instances, a single URL may point to a Web page that has active content which varies based on a number of factors. Such factors may, for example, include characteristics associated with the person, account or device that is requesting or otherwise accessing the file. Thus, for example, a Web page may be modified to reflect a previous purchasing history or a geographical location. Consequently, multiple unique Web pages may be identified by the same URL. Thus, it has been difficult to uniquely identify data source files such as Web pages.

Networks may also provide a medium for the sharing of information such as comments, opinions, views, and/or suggestions between multiple participants. Such sharing is commonly referred to as a forum, without regard to the particular physical manifestation. Forums exist for a wide variety of topics, for instance, politics, news, companies, music, books, movies, as well as various products.

Forums may be moderated, where a select individual or entity (i.e., the moderator) is responsible for policing the content of the forum. Alternatively, forums may be un-moderated, with no authority designated to control the content, other than the self-restraint of the participants. A moderated forum provides a number of distinct advantages over unmoderated forums. For example, a moderator can keep the forum focused on the particular subject to which the forum is devoted. A moderator may also filter or remove defamatory or insulting information or fraudulent information. However, moderated forums are often moderated by an entity that has a self interest in the subject of the forum. For instance, a company or other entity that sells a given product may host a forum directed to the particular product or products of a particular type. Such a company or other entity has a self interest in allowing comments favorable to itself or its product, while filtering or removing comments unfavorable to itself or its product. Likewise, the company or other entity has an interest in allowing comments that are disfavorable to a competitor or its product, as well as preventing comments that are favorable to the competitor or its product. Thus, many believe that unmoderated forums allow for more honest exchange of views.

Internet users today are constantly looking to share and search for new information on a vast number of topics. However, when Internet users find results, it is typically biased information. Two examples can illustrate how Internet content can be manipulated. Search results from the common search engines can be manipulated to place specific Web pages at the top of the search list. This practice is called SEO (Search Engine Optimization) and has a large number of professionals who can offer their services to the highest bidder. As noted above, Web forums are under the control of the Web page owner, who may manipulate or omit user comments that do not further the owner's own goals. The “terms of use” for a Web site frequently outlines this right of the site owner. Internet users strongly desire a solution designed to deliver un-biased opinions. Hence, new approaches to fostering the exchange of information in networked systems are desirable.

### BRIEF SUMMARY

A computer-implemented method of interacting with data source files stored on computer-readable media and identified by logical addresses may be summarized as including computationally identifying a number of keys from a content of a data source file to be considered in determining a subject of the data source file based at least in part on at least one of: a frequency of appearance of the key in the content of the data source file, a component type associated with the key in the content of the data source file, an indication indicative of at least a presence of a combination of alpha characters and non-alpha characters in the key, a formatting characteristic assigned to the key in the content of the data source file, a tuple size associated with the key, or a lack of inclusion of the key in a dictionary; computationally identifying a number of keys from the content of the data source file to be ignored in determining the subject of the data source file based at least in part on at least one of an inclusion of the key in set of core language words, an inclusion of the key in a domain specification portion of a uniform resource locator, an association of the key in the content of the data source file with a first subset of component types and not with a second subset of component types, or a formatting characteristic assigned to the key in the content of the data source file; computationally applying weights to at least some of the keys that are computationally identified to be considered and not computationally identified to be ignored; and computationally determining the subject of the data source file based at least in part on a result of computationally applying the weights.

The method may further include parsing the content of the data source file into a plurality of keys before identifying the number of keys to either be considered or ignored in determining the subject of the data source file. The method may further include parsing the content of the data source file into a plurality of keys of multiple tuples before identifying the number of keys to either be considered or ignored in determining the subject of the data source file; and computationally assigning each of the keys a respective tuple size equal to a number of words contained in a string of characters that form the key. Computationally identifying a number of keys from a content of a data source file to be considered in determining a subject of the data source file may include computationally identifying a number of strings of characters in the content of the data source file. Computationally identifying a number of keys from a content of a data source file to be considered in determining a subject of the data source file may include computationally identifying a number of strings of characters in the content of a Webpage source file. Computationally identifying a number of keys from a content of a data source file to be considered in determining a subject of the data source file based at least in part on a component type associated with the key in the content of the data source file may include computationally determining whether the key is associated with a title tag, a meta element tag, a keyword tag, a description tag, or an alternative tag of a Hypertext Markup Language (HTML). Computationally identifying a number of keys from a content of a data source file to be considered in determining a subject of the data source file based at least in part on a formatting characteristic assigned to the key in the content of the data source file may include computationally determining whether the key is associated with a specific heading level, a specific font size, a bold formatting style, an italic formatting style, an underline formatting style, a specific color, or a specific visibility state of a Hypertext Markup Language (HTML) or Cascading Style Sheet. Computationally applying weights to at least some of the keys that are computationally identified to be considered and not computationally identified to be ignored may include computationally applying weights based at least in part on at least one of: a frequency of appearance of the key in the content of the data source file, a frequency of appearance of the key in multiple portions of the content of the data source file, a lack of appearance of the key in a domain portion of a uniform resource locator that identifies the data source file, an appearance of the key in a non-domain portion of the uniform resource locator, a format associated with the key in the content of the data source file or a position of a key on a Web page, for example proximate a top of a Web page. The method may further include in response to a request for a particular data source file, providing a forum logically related to the determined subject of the data source file, the forum including a number of messages contextually related to the determined subject of the data source. Providing a forum logically related to the determined subject of the data source file may include providing the forum in a format to be displayed in forum window in addition to a main window of a browser that displays an image defined by the requested data source file. Providing a forum logically related to a determined subject of the data source file may include providing the forum controlled by an entity that is not controlled by an authority that controls a content of the data source file. The method may further include logically associating a plurality of data source files with a single forum where each of the data source files of the plurality of data source files have a respective determined subject in common. The method may further include computationally identifying a number of messages based on the determined subject of the data source file; and providing at least one of the messages as part of the forum logically related to the determined subject of the data source file. Computationally identifying a number of messages based on the determined subject of the data source file may include computationally determining a number of advertisements. Providing at least one of the messages as part of the forum logically related to the determined subject of the data source file may include providing the at least one message from a source that is not controlled by an authority that controls the content of the data source file. Computationally identifying a number of messages based on the determined subject of the data source file may include computationally identifying the number of messages based on an abstraction of the determined subject of the data source file. The method may further include computationally identifying a number of messages based on a determined subject of each of a plurality of data source files previously requested by a user; and providing at least one of the messages as part of the forum logically related to the determined subject of the data source file. The method may further include computationally identifying a number of messages based on a browsing history of a user; and providing at least one of the messages as part of the forum logically related to the determined subject of the data source file. Computationally identifying a number of messages based on a determined subject of each of a plurality of data source files previously requested by a user may include computationally identifying the number of messages based on an abstraction of the determined subject of each of a plurality of data source files previously requested by the user.

A networked computing system may be summarized as including at least one networked server system, including at least one processor and at least one processor-readable storage medium that stores instructions that when executed by the at least one processor causes the at least one processor to associate a number of logical network addresses of a plurality of data source files with a number of logical network addresses of a number of forums based on subject, where some of the data source files are identified by multiple logical network addresses and where a content of some of the data source files identified by a single logical network address differs based on an active content component of the source data file, by: for each of a number of data source files, computationally identifying a number of keys from the content of the data source file to be considered in determining a subject of the data source file based on a raw content of the data source file, a formatting of the content of the data source file and an organizational aspect of a presentation of the content of the data source file; computationally identifying a number of keys from the content of the data source file to be ignored in determining the subject of the data source file based on a raw content of the data source file, a formatting of the content of the data source file and an organizational aspect of a presentation of the data source file; computationally applying weights to at least some of the keys that are computationally identified to be considered and not computationally identified to be ignored; and computationally determining the subject of the data source file based at least in part on a result of computationally applying the weights.

Computationally identifying a number of keys from the content of the data source file to be considered in determining a subject of the data source file on a raw content of the data source file, a formatting of the content of the data source file and an organizational aspect of a presentation of the content of the data source file may include computationally identifying a number of keys from the content of the data source file to be considered in determining a subject of the data source file based at least in part on at least one of: a frequency of appearance of the key in the content of the data source file, a component type associated with the key in the content of the data source file, an indication indicative of at least a presence of a combination of alpha characters and non-alpha characters in the key, a formatting characteristic assigned to the key in the content of the data source file, a tuple size associated with the key, or a lack of inclusion of the key in a dictionary. Computationally identifying a number of keys from the content of the data source file to be ignored in determining the subject of the data source file based on a raw content of the data source file, a formatting of the content of the data source file, and an organizational aspect of a presentation of the content of the data source file may include computationally identifying the number of keys from the content of the data source file to be ignored in determining the subject of the data source file based at least in part on at least one of an inclusion of the key in set of core language words, an inclusion of the key in a domain specification portion of a uniform resource locator, an association of the key in the content of the data source file with a first subset of component types and not with a second subset of component types, or a formatting characteristic assigned to the key in the content of the data source file. The instructions may cause the at least one processor to associate a number of logical network addresses of a plurality of data source files with a number of logical network addresses of a number of forums based on subject, further by: parsing the content of the data source file into a plurality of keys of multiple tuples before identifying the number of keys to either be considered or ignored in determining the subject of the data source file; and computationally assigning each of the keys a respective tuple size equal to a number of words contained in a string of characters that form the key. Computationally identifying a number of keys from a content of a data source file to be considered in determining a subject of the data source file may include computationally identifying a number of strings of characters in the content of a Webpage source file. Computationally identifying a number of keys from a content of a data source file to be considered in determining a subject of the data source file based at least in part on a component type associated with the key in the content of the data source file may include computationally determining whether the key is associated with at least one of a title tag, a meta element tag, a keyword tag, a description tag, or an alternative tag of a Hypertext Markup Language (HTML). Computationally identifying a number of keys from a content of a data source file to be considered in determining a subject of the data source file based at least in part on a formatting characteristic assigned to the key in the content of the data source file may include computationally determining whether the key is associated with at least one of a specific heading level, a specific font size, a bold formatting style, an italic formatting style, an underline formatting style, a specific color, or a specific visibility state of a Hypertext Markup Language (HTML) or Cascading Style Sheet. Computationally applying weights to at least some of the keys that are computationally identified to be considered and not computationally identified to be ignored may include computationally applying weights based at least in part on at least one of: a frequency of appearance of the key in the content of the data source file, a frequency of appearance of the key in multiple portions of the content of the data source file, a lack of appearance of the key in a domain portion of a uniform resource locator that identifies the data source file, or a format associated with the key in the content of the data source file. In response to a request for one of the data source files the instructions may cause the at least one processor to provide a forum logically related to the determined subject of the requested one of the data source files, by: providing the forum which is controlled by an entity that is not controlled by an authority that controls a content of the requested data source file in a format to be displayed in forum window in addition to a main window of a browser that displays an image defined by the requested data source file. In response to a request for one of the data source files the instructions may cause the at least one processor to provide at least one message contextually related to the determined subject of the requested one of the data source files, by: computationally identifying a number of messages based on the determined subject of the data source file; and providing at least one of the messages as part of the forum logically related to the determined subject of the data source file. In response to a request for one of the data source files the instructions may cause the at least one processor to provide at least one advertisement, by: computationally identifying a number of advertisements based on a determined subject of each of a plurality of data source files previously requested by a user; and providing at least one of the advertisements as part of the forum logically related to the determined subject of the data source file. The networked computing system may further include at least one networked client computing system including at least one processor and at least one processor-readable storage medium that stores browser instructions that when executed by the at least one processor cause the at least one processor to display information, by: requesting one of the data source files; displaying a presentation defined by the requested data source file; and displaying a forum of comments logically associated with the requested data source filed based on the determined subject of the requested data source file.

A computer-readable medium may be summarized as including storing instructions that when executed by a server computing system cause the server computing system to associate a number of logical network addresses of a plurality of data source files with a number of logical network addresses of a number of forums based on subject matter, where some of the data source files are identified by multiple logical network addresses and where a content of some of the data source files identified by a single logical network address differs based on an active content component of the source data file, by: for each of a number of data source files, computationally identifying a number of keys from the content of the data source file to be considered in determining a subject of the data source file based on a raw content of the data source file, a formatting of the content of the data source file and an organizational aspect of a presentation of the content of the data source file; computationally identifying a number of keys from the content of the data source file to be ignored in determining the subject of the data source file based on a raw content of the data source file, a formatting of the content of the data source file and an organizational aspect of a presentation of the data source file; computationally applying weights to at least some of the keys that are computationally identified to be considered and not computationally identified to be ignored; and computationally determining the subject of the data source file based at least in part on a result of computationally applying the weights.

Computationally identifying a number of keys from the content of the data source file to be considered in determining a subject of the data source file on a raw content of the data source file, a formatting of the content of the data source file and an organizational aspect of a presentation of the content of the data source file may include computationally identifying a number of keys from the content of the data source file to be considered in determining a subject of the data source file based at least in part on at least one of: a frequency of appearance of the key in the content of the data source file, a component type associated with the key in the content of the data source file, an indication indicative of at least a presence of a combination of alpha characters and non-alpha characters in the key, a formatting characteristic assigned to the key in the content of the data source file, a tuple size associated with the key, or a lack of inclusion of the key in a dictionary. Computationally identifying a number of keys from the content of the data source file to be ignored in determining the subject of the data source file based on a raw content of the data source file, a formatting of the content of the data source file, and an organizational aspect of a presentation of the content of the data source file may include computationally identifying the number of keys from the content of the data source file to be ignored in determining the subject of the data source file based at least in part on at least one of an inclusion of the key in set of core language words, an inclusion of the key in a domain specification portion of a uniform resource locator, an association of the key in the content of the data source file with a first subset of component types and not with a second subset of component types, or a formatting characteristic assigned to the key in the content of the data source file. The instructions may cause the at least one processor to associate a number of logical network addresses of a plurality of data source files with a number of logical network addresses of a number of forums based on subject, further by: parsing the content of the data source file into a plurality of keys of multiple tuples before identifying the number of keys to either be considered or ignored in determining the subject of the data source file; and computationally assigning each of the keys a respective tuple size equal to a number of words contained in a string of characters that form the key. Computationally identifying a number of keys from a content of a data source file to be considered in determining a subject of the data source file may include computationally identifying a number of strings of characters in the content of a Webpage source file. Computationally identifying a number of keys from a content of a data source file to be considered in determining a subject of the data source file based at least in part on a component type associated with the key in the content of the data source file may include computationally determining whether the key is associated with a title tag, a meta element tag, a keyword tag, a description tag, or an alternative tag of a Hypertext Markup Language (HTML). Computationally identifying a number of keys from a content of a data source file to be considered in determining a subject of the data source file based at least in part on a formatting characteristic assigned to the key in the content of the data source file may include computationally determining whether the key is associated with a specific heading level, a specific font size, a bold formatting style, an italic formatting style, an underline formatting style, a specific color, or a specific visibility state of a Hypertext Markup Language (HTML) or Cascading Style Sheet. Computationally applying weights to at least some of the keys that are computationally identified to be considered and not computationally identified to be ignored may include computationally applying weights based at least in part on at least one of: a frequency of appearance of the key in the content of the data source file, a frequency of appearance of the key in multiple portions of the content of the data source file, a lack of appearance of the key in a domain portion of a uniform resource locator that identifies the data source file, or a format associated with the key in the content of the data source file. In response to a request for one of the data source files the instructions may cause the at least one processor to provide a forum logically related to the determined subject of the requested one of the data source files, by: providing the forum which is controlled by an entity that is not controlled by an authority that controls a content of the requested data source file in a format to be displayed in forum window in addition to a main window of a browser that displays an image defined by the requested data source file. In response to a request for one of the data source files the instructions may cause the at least one processor to provide at least one message contextually related to the determined subject of the requested one of the data source files, by:

computationally identifying a number of messages based on the determined subject of the data source file; and providing at least one of the messages as part of the forum logically related to the determined subject of the data source file. In response to a request for one of the data source files the instructions may cause the at least one processor to provide at least one advertisement, by:
computationally identifying a number of advertisements based on a determined subject of each of a plurality of data source files previously requested by a user; and providing at least one of the advertisements as part of the forum logically related to the determined subject of the data source file.

In particular, the above may provide a ubiquitous, free-speech discussion and information forum for the Internet is desirable. The above may also provide a very unique online advertising platform—any advertising message can be associated with any Web page. Algorithms used to uniquely identify the subject of the Internet page provide a significant benefit over other approaches. Other products with similar requirements use the Web page's address (e.g., URL) to uniquely identify the Web page. However, this is not effective as there are many instances when there are multiple URLs that point to the same page content or the same URL can point to different page content.

Analysis of a Web page on the Internet to determine keys which can uniquely identify the page and distinguish it from the multitude of other pages within the domain allows the tying of comments to the subject of the Web page. There is also a possibility of uniquely identify the Web page on the Internet. The analysis employs three unique classes of algorithms: suggestion algorithms, elimination algorithms and weighting algorithms. Within each class of algorithms, there are multiple individual algorithms or “sub-algorithms” that are executed by a processor. The results from each of the sub-algorithms may be combined to produce an individual weighting for each key, with the greater the weighting, the more relevant the key is for identifying the subject of the Web page. In all three algorithm classes, the Web page is analyzed, including the raw content, formatting and overall presentation. Most solutions to this problem today utilize the Universal Resource Locator (URL) to identify a Web page. However, there are many Web page instances where there are multiple URLs that point to the same Web page content. For example, you can get to the same page on the AMAZON® domain with the book's title or the book's ISBN number in the URL. Conversely, there are a number of pages with different content that have the same URL. For example, some pages utilize your geographic location, for example using a requester or client IP address, to present different, more geographically appropriate content. So the URL is not a reliable mechanism to uniquely identify a Web page. The approach described herein may solve that problem.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment including a number of servers, a number of clients communicatively coupled to the servers by one or more networks and a subject based communication facilitation system, according to one illustrated embodiment.

FIG. 2 is a schematic diagram of a subject based communication facilitation system including a subject based communication facilitation server computing system and a database stored on computer-readable media, according to one illustrated embodiment.

FIG. 3 is a screen print of a Webpage, according to one illustrated embodiment.

FIG. 4 is a screen print of a data source file in the form of an Hypertext Markup (HTML) file, according to one illustrated embodiment.

FIG. 5A is a schematic diagram of a database schema stored on computer-readable media, according to one illustrated embodiment.

FIG. 5B is a schematic diagram of a database schema stored on computer-readable media, according to another illustrated embodiment.

FIGS. 6A and 6B are a flow diagram showing a method of interacting with data source files stored on computer-readable media and identified by logical addresses, according to one illustrated embodiment.

FIG. 7 is a flow diagram showing a method of computationally identifying keys, according to one illustrated embodiment.

FIG. 8 is a flow diagram showing a method of computationally identifying keys, according to another illustrated embodiment.

FIG. 9 is a flow diagram showing a method of computationally identifying a number of keys from a content of a data source file to be considered in determining a subject of the data source file based at least in part on a component type associated with the key in the content of the data source file, according to one illustrated embodiment.

FIG. 10 is a flow diagram showing a method of computationally identifying a number of keys from a content of a data source file to be considered in determining a subject of the data source file based at least in part on a formatting characteristic assigned to the key in the content of the data source file, according to one illustrated embodiment.

FIG. 11 is a flow diagram showing a method of computationally applying weights to at least some of the keys that are computationally identified to be considered and not computationally identified to be ignored, according to yet another illustrated embodiment.

FIG. 12 is a flow diagram showing a method of providing a forum, according to one illustrated embodiment.

FIG. 13 is a flow diagram showing a method of providing a forum, according to another illustrated embodiment.

FIG. 14 is a flow diagram showing a method of providing a forum, according to another illustrated embodiment.

FIG. 15 is a flow diagram showing a method of identifying messages based on the determined subject of the data source file, according to one illustrated embodiment.

FIG. 16 is a flow diagram showing a method of identifying messages based on the determined subject of the data source file, according to another illustrated embodiment.

FIG. 17 is a flow diagram showing a method of identifying messages, according to one illustrated embodiment.

FIG. 18 is a flow diagram showing a method of identifying messages based on previous requests, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and servicer computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

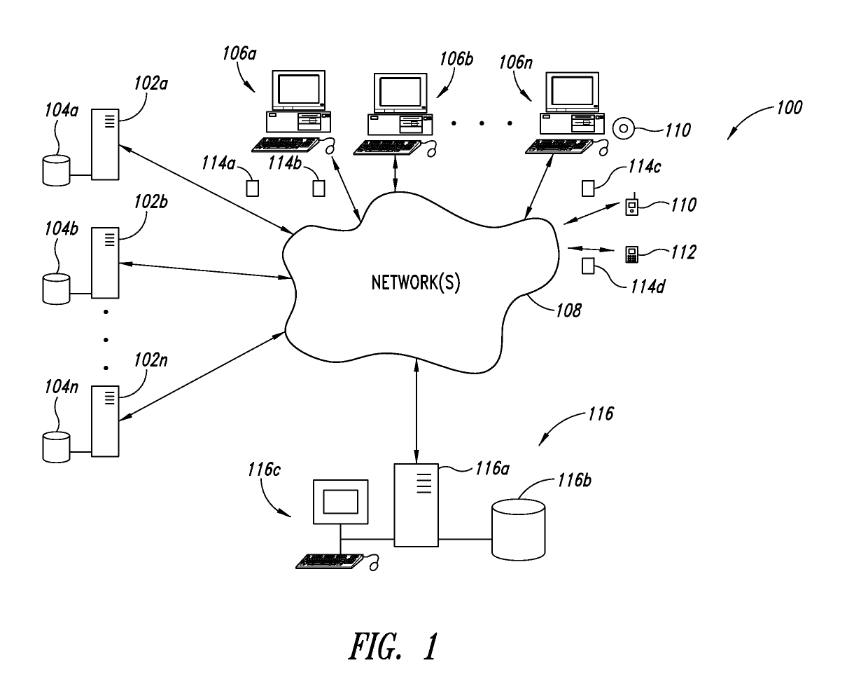

FIG. 1 shows a network environment 100, according to one illustrated embodiment.

The network environment 100 includes a number of server computing systems 102a-102n (collectively 102). The server computing systems 102 include processors that execute server instructions (i.e., server software) stored on computer-readable media to provide server functions in the network environment 100. For example, the server computing systems 102 may serve files stored in one or more databases or other computer-readable storage media 104a-104n (collectively 104).

The network environment 100 includes a number of client computing systems 106a-106n (collectively 106) selectively communicatively coupled to one or more of the server computing systems 102 via one or more communications networks 108. The client computing systems 106 include processor that execute one or more sets of communications instructions (e.g., browser) stored on any of a variety of computer-readable media 110 (only one illustrated in FIG. 1). The client computing systems 106 may take a variety of forms, for instance desktop or laptop personal computers, work stations, mini-computers, mainframe computers, or other computational devices with microprocessors or microcontrollers which are capable of networked communications. The client computing systems 106 may be communicatively coupled to the rest of the network 108 via wired, wireless or a combination of wired and wireless communications channels.

The network environment 100 includes a number of telecommunications devices 110 (only one illustrated). Such telecommunications devices 110 may, for example, take the form of Internet or Web enabled cellular phones. The network environment 100 also includes a number of personal digital assistant (PDA) devices 112 (only one illustrated). Such PDA devices 112 may, for example, take the form of Internet or Web enabled PDAs (e.g., iPHONE®, TREO®, BLACKBERRY®), which may, for example, execute a set of browser instructions or program. The network environment 100 may include any number of a large variety of other devices that are capable of some type of networked communications. The telecommunications devices 110, PDA devices 112, as well as any other devices, may be communicatively coupled to the rest of the network 108 via wired, wireless or a combination of wired and wireless communications channels.

The one or more communications networks 108 may take a variety of forms. For instance, the communications networks 108 may include wired, wireless, optical, or a combination of wired, wireless and/or optical communications links. The one or more communications networks 108 may include public networks, private networks, unsecured networks, secured networks or combinations thereof. The one or more communications networks 108 may employ any one or more communications protocols, for example TCP/IP protocol, UDP protocols, IEEE 802.11 protocol, as well as other telecommunications or computer networking protocols. The one or more communications networks 108 may include what are traditionally referred to as computing networks and/or what are traditionally referred to as telecommunication networks or combinations thereof. In at least one embodiment, the one or more communications networks 108 includes the Internet, and in particular, the Worldwide Web or (referred to herein as “the Web”). Consequently, in at least one embodiment, one or more of the server computing systems 102 execute server software to serve HTML source files or Web pages 114a-114d (collectively 114), and one or more client computing systems 106, telecommunications devices 110 and/or PDAs 112 execute browser software to request and display HTML source files or Web pages 114.

The network environment 100 includes a subject based communication facilitation system 116. The subject based communication facilitation system 116 may include one or more subject based communication facilitation servers 116a, databases 116b and an optional control terminals 116c.

The one or more subject based communication facilitation servers 116a execute instructions stored on computer-readable media that cause the subject based communication facilitation servers 116a to identify a subject of a file, for example a subject of an HTML source file, based on a number of criteria regarding a content of the data source file. The instructions may cause the subject based communication facilitation servers 116a to identify a single file, for example a single Web page source file, even where two or more logical addresses identify the same file. The instructions may cause the subject based communication facilitation servers 116a to identify multiple instances of files where, while a single logical address points to the file, the content of the file is different based on some factor, for example where the content of the file is modified based on characteristics of the client accessing the file or a time that the file is accessed. For instance, a Web page may have active content that is modified to reflect a characteristic of the client accessing the Web page, for instance a geographical location of the client or a purchasing or browsing history of the client which represent previous purchases or previous Web page requests by the client. Thus, the subject based communication facilitation system 116a may solve existing problems.

The instructions may also cause the subject based communication facilitation servers 116a to provide information to a client computing system or other device that requested the file (e.g., Web page). For example, instructions may also cause the subject based communication facilitation servers 116a to provide a forum directed or otherwise related to the determined subject of the requested file to a client computing system or other device that requested the file (e.g., Web page). The forum may allow the sharing of information between multiple participants, including comments, opinions, views and/or suggestions. The subject based communication facilitation servers 116a may provide such in a form that causes the client computing system 106 or other device 110, 112 to display the forum. Also for example, instructions may also cause the subject based communication facilitation servers 116a to provide one or more messages directed or otherwise related to the determined subject of the requested file to a client computing system 106 or other device 110, 112 that requested the file (e.g., Web page). The subject based communication facilitation servers 116a may provide such in a form that causes the client computing system 106 or other device 110, 112 to display the message(s). Such message(s) may take a variety of forms, which may include advertisements or advertising. Also for example, instructions may also cause the subject based communication facilitation servers 116a to provide one or more messages that are based on previous requests by the client computing system 106 or other device 110, 112, for example a browsing history associated with the client computing system 106 or other device 110, 112, or user of such. The subject based communication facilitation servers 116a may provide the messages in a form that causes the client computing system 106 or other device 110, 112 to display the message(s). Such message(s) may take a variety of forms, which may include advertisements or advertising.

The one or more subject based communication facilitation databases 116b may store information used to identify the subject of files. The one or more subject based communication facilitation databases 116b may store information used to logically associate the subject of files to one or more appropriate forums.

The one or more subject based communication facilitation databases 116b may store information used to maintain one or more forums. Thus, the forums may be independent of an authority that controls the content of the requested files. Those forums may or may not be moderated, but in any case may be independent of control by any entities to which the forum may relate. The one or more subject based communication facilitation databases 116b may store messages and information used to logically associate the messages to the subject. The one or more databases 116b may store information used to logically associate messages with previous requests, for example a browsing history of the requester.

The one or more control terminals may provide a user interface to interact with and control operation of the one or more subject based communication facilitation servers 116a and/or databases 116b.

The operation of the one or more subject based communication facilitation servers 116a and databases 116b to implement such are discussed in detail below.

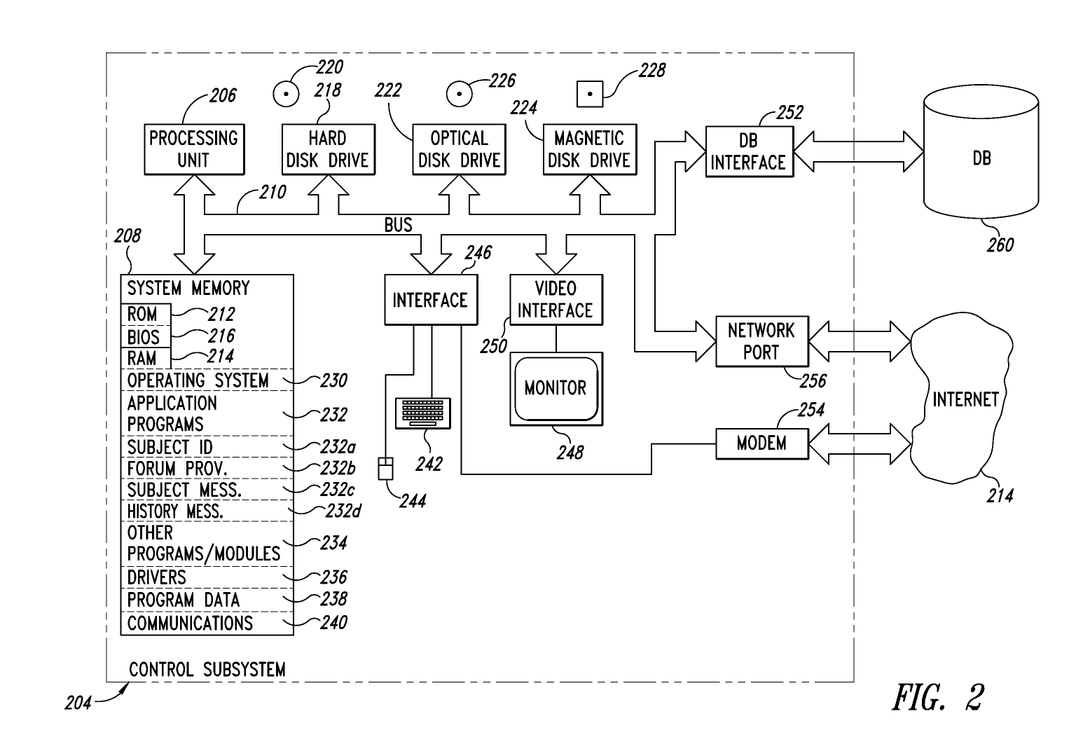

FIG. 2 and the following discussion provide a brief, general description of a suitable subject based communication facilitation system 200 in which the various illustrated embodiments can be implemented. The subject based communication facilitation system 200 may, for example, implement the various functions and operations discussed immediately above in reference to the subject based communication facilitation system 116 of FIG. 1.

Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The subject based communication facilitation system 200 may include one or more subject based communication facilitation server computing systems 204 (only one illustrated in FIG. 2). The subject based communication facilitation server computing systems 204 may take the form of a conventional PC or server executing instructions. The subject based communication facilitation server computing system 204 includes a processing unit 206, a system memory 208 and a system bus 210 that couples various system components including the system memory 208 to the processing unit 206. The subject based communication facilitation server computing system 204 will at times be referred to in the singular herein, but this is not intended to limit the embodiments to a single system, since in certain embodiments, there will be more than one system or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 206 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be understood by those skilled in the relevant art.

The system bus 210 can employ any known bus structures or architectures, including a memory bus with memory controller, a peripheral bus, and a local bus. The system memory 208 includes read-only memory (“ROM”) 212 and random access memory (“RAM”) 214. A basic input/output system (“BIOS”) 216, which can form part of the ROM 212, contains basic routines that help transfer information between elements within the control subsystem 304, such as during start-up. Some embodiments may employ separate buses for data, instructions and power.

The subject based communication facilitation server computing system 204 also includes a hard disk drive 218 for reading from and writing to a hard disk 220, and an optical disk drive 222 and a magnetic disk drive 224 for reading from and writing to removable optical disks 226 and magnetic disks 228, respectively. The optical disk 226 can be a CD or a DVD, while the magnetic disk 228 can be a magnetic floppy disk or diskette. The hard disk drive 218, optical disk drive 222 and magnetic disk drive 224 communicate with the processing unit 206 via the system bus 210. The hard disk drive 218, optical disk drive 222 and magnetic disk drive 224 may include interfaces or controllers (not shown) coupled between such drives and the system bus 210, as is known by those skilled in the relevant art. The drives 218, 222, 224, and their associated computer-readable media 220, 226, 228, provide nonvolatile storage of computer-readable instructions, data structures, program modules and other data for the subject based communication facilitation server computing system 204. Although the depicted subject based communication facilitation server computing system 204 employs hard disk 220, optical disk 226 and magnetic disk 228, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

Program modules can be stored in the system memory 208, such as an operating system 230, one or more application programs 232, other programs or modules 234, drivers 236 and program data 238.

The application programs 232 may, for example, include subject identification logic 232a, forum provision logic 232b, subject based messaging logic 232c, and history based messaging logic 232d. The logic 232a-232d may, for example, be stored as one or more executable instructions. As discussed in more detail below, the subject identification logic 232a may include logic or instructions to parse contents of files, determine a subject of the file, and associated logical addresses of files with the determined subject. Such, may for example, allow unique identification of files based on subject, for example identification of Web pages based on subject. The forum provision logic 332b may include logic or instructions to associate forums to files based on a determined subject of the file, and/or to maintain the forum. As discussed in more detail below, the subject based messaging logic 332b may also include logic to associate messages, for instance advertisements, with requested files, for instance Web pages, and to provide the forum to a requester of the file. As discussed in detail below, the history based messaging logic 332d may include logic or instructions to associate messages, for example advertisements, with a file, for example a Web page, based on a history of previous requests by a requester, for example a computing system or end user. Such logic 332 may execute the methods or processes set out in the various flow charts discussed below.

The system memory 208 may also include communications programs 240, for example a server program and/or a Web client or browser program that permit the subject based communication facilitation server computing system 204 to access and exchange data with other systems or components, such as client computing systems 106, telecommunications devices 110 and/or PDAs 112 (FIG. 1), Web sites on the Internet, corporate intranets, or other networks as described below. The communications programs 240 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 2 as being stored in the system memory 208, the operating system 230, application programs 232, other programs/modules 234, drivers 236, program data 238 and server and/or browser 240 can be stored on the hard disk 220 of the hard disk drive 218, the optical disk 226 of the optical disk drive 222 and/or the magnetic disk 228 of the magnetic disk drive 224. A user can enter commands and information into the subject based communication facilitation server computing system 204 through input devices such as a touch screen or keyboard 242 and/or a pointing device such as a mouse 244. Other input devices can include a microphone, joystick, game pad, tablet, scanner, biometric scanning device, etc. These and other input devices are connected to the processing unit 206 through an interface 246 such as a universal serial bus (“USB”) interface that couples to the system bus 210, although other interfaces such as a parallel port, a game port or a wireless interface or a serial port may be used. A monitor 248 or other display device is coupled to the system bus 310 via a video interface 250, such as a video adapter. Although not shown, the control subsystem 304 can include other output devices, such as speakers, printers, etc.

The subject based communication facilitation server computing system 204 operates in a networked environment 100 (FIG. 1) using one or more of the logical connections to communicate with one or more remote computers, servers and/or devices via one or more communications channels, for example, one or more networks, for example the Internet and/or Web 214. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a WAN networking environment, the subject based communication facilitation server computing system 204 may include a modem 254 for establishing communications over the WAN, for instance the Internet or Web 214. The modem 254 is shown in FIG. 2 as communicatively linked between the interface 246 and the Internet or Web 214. Additionally or alternatively, another device, such as a network port 256, that is communicatively linked to the system bus 210, may be used for establishing communications over the Internet or Web 214. Further, one or more network interfaces 252, that are communicatively linked to the system bus 210, may be used for establishing communications over a LAN. In particular, a database interface 252 may provide communications with one or more databases stored on one or more computer-readable media 260.

In a networked environment 100 (FIG. 1), program modules, application programs, or data, or portions thereof, can be stored in a server computing system (not shown). Those skilled in the relevant art will recognize that the network connections shown in FIG. 2 are only some examples of ways of establishing communications between computers, and other connections may be used, including wirelessly. In some embodiments, program modules, application programs, or data, or portions thereof, can even be stored in one of the client computing systems 106 (FIG. 1) or devices 110, 112, for example as a “cookie” stored on a computer-readable storage medium of the client computing system or device.

For convenience, the processing unit 206, system memory 208, network port 256 and interfaces 246, 252 are illustrated as communicatively coupled to each other via the system bus 210, thereby providing connectivity between the above-described components. In alternative embodiments of the subject based communication facilitation server computing system 204, the above-described components may be communicatively coupled in a different manner than illustrated in FIG. 2. For example, one or more of the above-described components may be directly coupled to other components, or may be coupled to each other, via intermediary components (not shown). In some embodiments, system bus 210 is omitted and the components are coupled directly to each other using suitable connections.

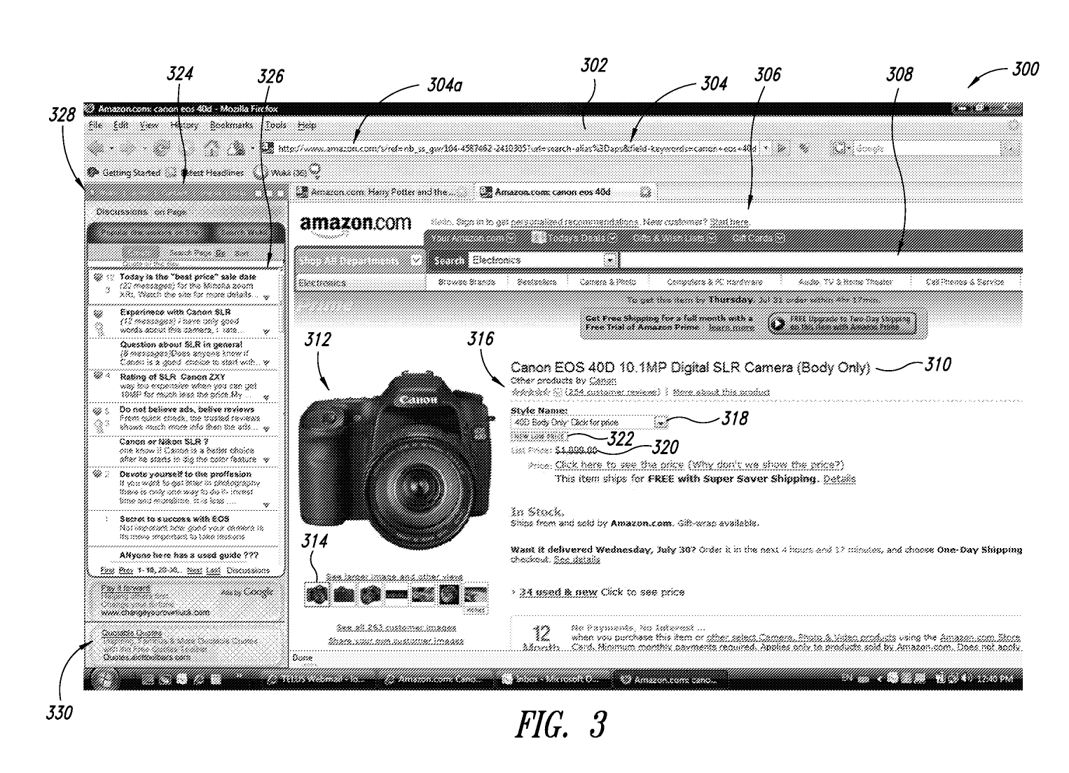

FIG. 3 shows a screen print of a user interface according to one illustrated embodiment, in the form of a browser screen 300 as displayed on a display of a client computing system 106, client telecommunications device 110 or client PDA 112 (FIG. 1).

The browser screen 300 includes a number of tool bars 302 with user selectable icons and/or menus to control operation of a browser application program executed by a client computing system 106, client telecommunications device 110 or client PDA 112 (FIG. 1). The browser screen 300 may also display a logical address of a requested file, for example a uniform resource locator (URL) 304 used to retrieve the file, including a domain portion 304a of the URL.

The browser screen 300 includes a browser window 306 in which results of a request for a file are displayed. The results of the file request may, for example, take the form of a Web page 308. The content of the Web page 308 may include text, character strings of alpha, numeric or other symbols, pictures, user selectable icons or menus, as well as various active content. For example, the content of the Web page 308 may include a product identifier 310, which may take the form of mixed alphanumeric characters. The content of the Web page 308 may include an image 312 such as a photograph or picture of the product. The content of the Web page 308 may include a menu 314 of other images of the product which may be selected for viewing by a user. The content of the Web page 308 may include a user selectable icon for accessing customer reviews 316 hosted on the retailer's Website. The content of the Web page 308 may include a pull-down menu 318 to select a style of the product where the product is offered in multiple styles. The content of the Web page 308 may include a suggested retail price or normal price 320 at which the product is typically offered. The content of the Web page 308 may include a user selectable icon to see a sales price or an actual price 322 at which the product is being offered. The content of the Web page 308 may include other descriptive information or use selectable icons to review such, for example information about the product or the shipping of the product, for example including any return policies.

The browser screen 300 or a window proximate the browser screen 300 may include a forum window 324 that displays a forum 326 that includes information about the subject of the currently displayed Web page 308. The information may include comments, opinions, views, and/or suggestions between multiple participants of the forum. The content of the forum 326 is preferably controlled by an entity that has no financial or other stake in sales of the product. Thus, the forum is preferably controlled by an entity that is not the manufacturer, distributor, retailer or wholesaler of the product or other subject of a Web page displayed in the browser window 306. The form window 324 may include one or more toolbars or user selectable icons 328 such as pull-down menus to allow a user to interact with the discussion forum. The forum window 324 may include messages, for instance one or more advertisements 330. The messages may be contextually related to the subject of the forum, and/or may be contextually related to a set of previous file requests by the user.

In one embodiment the forum is termed a Wukii™ universal discussion forum, and provides an interactive solution allowing mass collaboration in the ever-evolving and expanding Internet. The Wukii™ universal discussion forum may provide a ubiquitous platform for discussion and information sharing (“mass-collaboration). Discussions are associated with a specific Web page subject, thus creating a context-sensitive discussion forum. Within these forums, independent, un-moderated opinions and comments are available alongside the Web content, thus providing the ultimate research and collaboration tool. The next generation of Internet products are characterized by collaboration and communication—together they are democratizing the creation of content and value.

Each forum may be composed of a number of discussions, where each discussion has a single subject together with multiple messages. When a new discussion is added, an author submits both the subject and the initial message. When other users subsequently respond to the discussion, they provide only a message. In some embodiments, the user may respond to a specific message rather than the discussion as a whole, thus creating a fully “threaded” forum.

The Wukii™ universal discussion forum may also provide a unique opportunity for advertisers who wish to target a specific consumer. The person participating in or reviewing the forum is clearly interested in the subject and content of the Web page. The owner or entity that has control over the content of the Web page does not control the advertising content.

Wukii™ universal discussion forum may be an add-on or extension to a conventional Web browser. The main browser window 306 which displays the Web page 308 content is untouched by the Wukii™ universal discussion forum.

The Wukii™ universal discussion forum may execute as a client in a window that sits beside the main browser window. The Wukii™ universal discussion forum may present an alternate window that displays the discussions and information related to the subject of the Web page in the browser window. While illustrated in FIG. 3 with the forum on the left-hand side of the browser screen 300, the forum 326 displayed on either the left-hand or right-hand side of the screen 300, or at other positions. The default is to display the forum 326 on the right-hand side since the right-hand side is not considered “prime real estate” by most Web publishers.

All or some of the forums may also published on the Internet as Web pages. This may include all the discussions and messages for each forum. As part of the normal Internet procedure, each forum Web page may be systematically indexed by search engines, which leads to the forums ultimately being presented within Web search results. Of course each forum Web page may also contain advertising, where the advertising is again relevant to the subject of the forums or the Web pages. One additional benefit is that search engine indexing provides a general solution to searching through all of the forums. Thus, particular forums may be easily located by simply by doing a general Web search for specific terms but limiting the scope of the search to the particular forum domain.

FIG. 4 shows a data source file according to one illustrated embodiment, in the form of HTML code 400. The HTML code is not complete, but rather represents portions of HTML code that may be used to render a Web page such as that illustrated in FIG. 3. The HTML code may take a variety of forms, other than that illustrated in FIG. 4.

The HTML code 400 may include a title 402 identified by a title tag 404. The HTML code 400 may employ a cascading style sheet (CSS) 406 to set a style, for example setting a style for the title 402. The style may include a specification of color 406a, font type 406b, font size 406c and/or font weight 406d. The HTML code may include additional information identified by respective tags, as is generally know in the field of Web page development or layout.

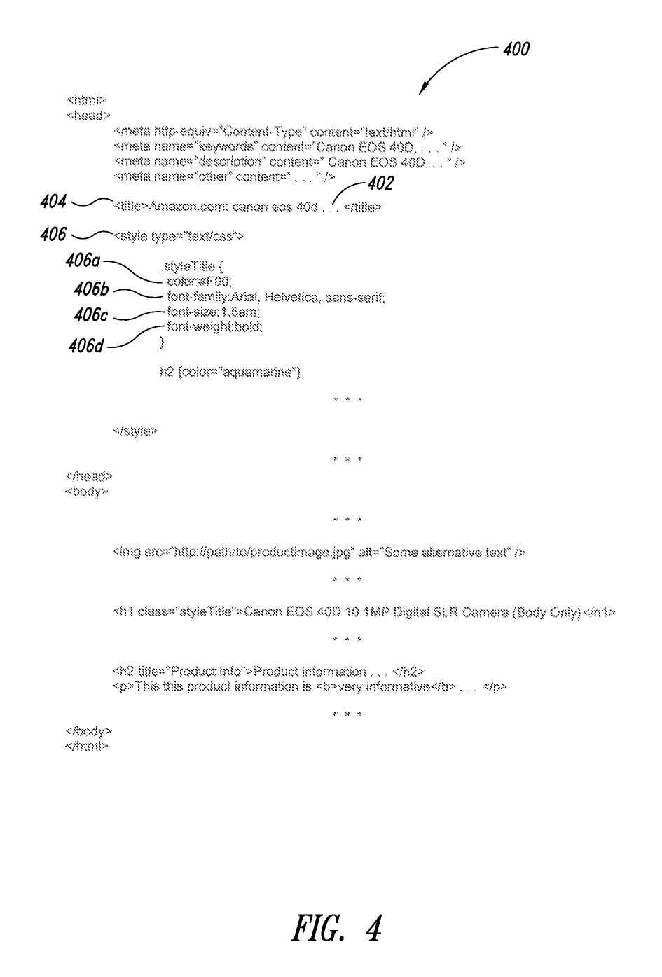

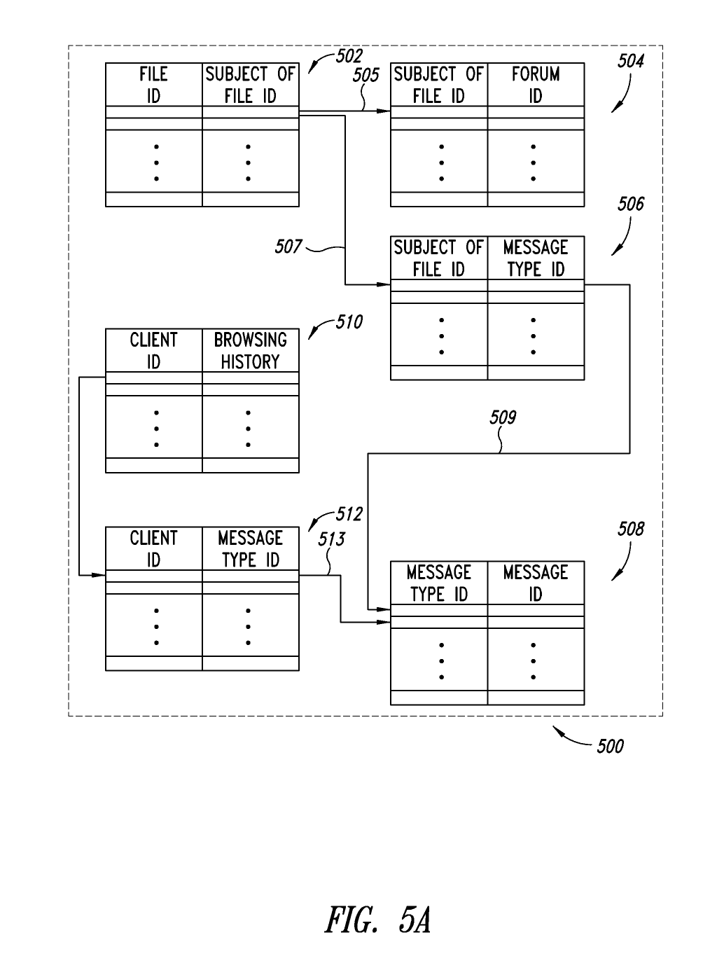

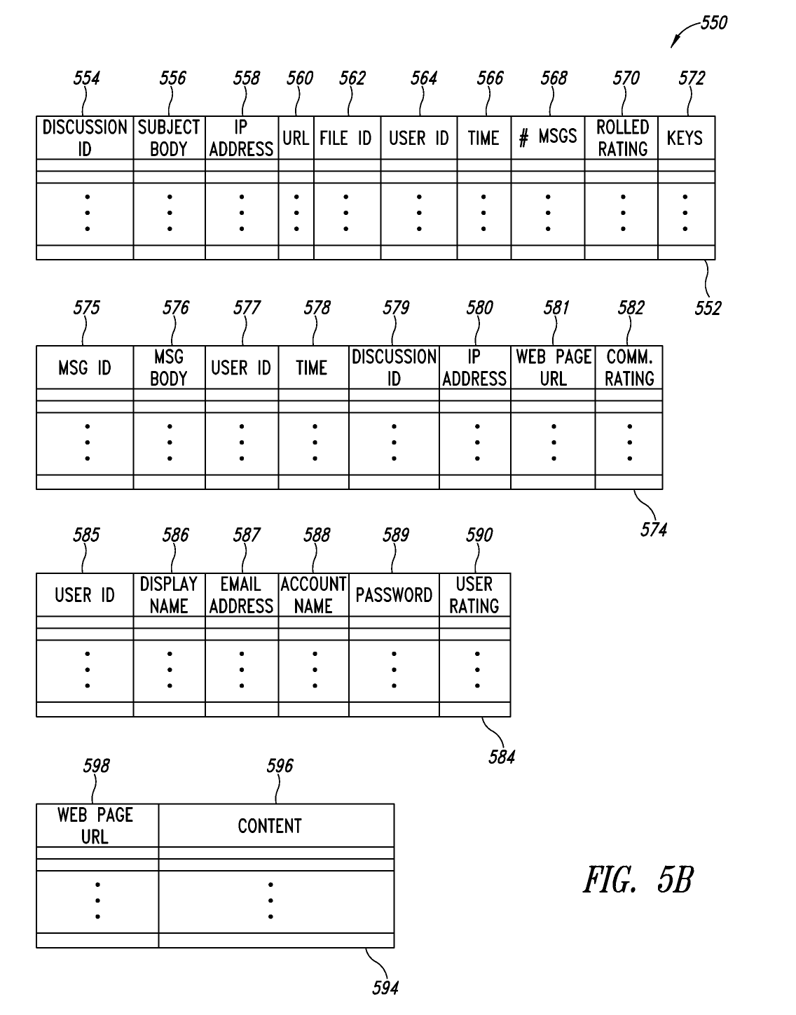

FIG. 5A shows a database schema 500 which may be employed in various embodiments of the subject based communication facilitation system, according to one illustrated embodiment. The database schema 500 may be stored on one or more physical media, for example computer-readable storage media. The database schema 500 may be stored locally to the subject based communication facilitation server system or remotely therefrom, or portions may be stored locally while other portions stored remotely. The database schema 500 employs a set of data structures that provide logical relationships between various elements of data. While illustrated as several tables, the database schema 500 may include additional tables, may eliminate some tables and/or employ other tables. Additionally, or alternatively, the database schema 500 may employ data structures other than, or in addition to, tables. For example, the database schema 500 may employ records, fields, and pointers, or other data structures.

The database schema 500 includes a file/subject data structure 502. The file/subject data structure 502 logically associates files with subjects. The files may be represented by file identifiers and the subjects represented by subject identifiers. The file identifiers may, for example, take the form of a logical address of the file as stored on a computer-readable medium, or a pointer to such a logical address. The logical address may, for example, take the form of a Uniform Resource Locator (URL) or Internet Protocol (IP) address that retrieves the file when entered into a browser executing on a networked computer. Subject identifiers may take a variety of forms, for example alphanumeric strings, which may, or may not, be human recognizable (e.g., text).

In some embodiments, the subject based communication facilitation system may routinely survey or “crawl” the network(s) for files, for example surveying the Web for Web pages. The subject based communication facilitation system may then determine a subject of the file, as described in detail below, and store such in the file/subject data structure 502, independent of any particular request for the file. Thus, the subject based communication facilitation system will have processed the file before a particular request for the file is made and cached the result. Such may enhance speed of operation. The subject based communication facilitation system may determine the subject of only new files, that is only files newly added since the last survey or crawl. Alternatively, the subject based communication facilitation system may determine the subject of all files including previously reviewed files, to ensure that the respective subjects of the files has not changed. In other embodiments, the subject based communication facilitation system employs an on demand approach, determining the subject of a file only in response to a request for the file. Still other embodiments may a combination of surveying and the on demand approach.

The database schema 500 includes a subject/forum data structure 504. The subject/forum data structure 504 logically associates subjects and forums. The subjects may be represented by subject identifiers. The subject identifiers may be the same as those used in the file/subject data structure 502, and thus serve as a key or pointer, as indicated by arrow 505. The forums may be represented by forum identifiers, which may, for example take the form of URLs or IP addresses. Forums are collections of shared information, typically in the form of comments, opinions, views, and/or suggestions between multiple participants. The forums may be moderated or unmoderated, or there may be a combination of moderated and unmoderated forums. The forums may be operated by an operator of the subject based communication facilitation system, or by some other entity. In at least some embodiments, the forums are independent of (i.e., not controlled by) any authority that controls a content of the data source file to which the subject or forum pertains. Such prevents an entity that has a financial, political or other motive, for example a manufacturer, retailer or politician, from selectively controlling the content posted to the forum.

The database schema 500 includes a subject/message type data structure 506. The subject/message type data structure 506 logically associates subjects with message types. The subjects may be represented by subject identifiers. The subject identifiers may be the same as those used in the file/subject data structure 502, and thus serve as a key or pointer, as indicated by arrow 507. Rather than identifying specific individual messages, the message types may represent an abstraction of the specific messages. Thus, the message types may represent a type of message, for instance messages geared toward defined demographics, subjects or interests. Thus, one message type may map to messages for consumer electronics while another maps to sporting goods and another to movies or other entertainment. One message type may map to kitchen goods, while another maps to kitchen appliances. One message may map to males in the age range of 20 to 30 years with a given income, while another may map to females in the age range of 30-40 with a given income. Thus, message types may identify the types of messages that are to be logically associated with specific subjects. Where a subject of a file such as a Web page is, for instance, high definition television (HDTV) liquid crystal display (LCD) televisions, the message type may indicate messages related to consumer electronics or to televisions. The messages types may be represented by message type identifiers, which may be textual identifiers that are easily understood by humans (e.g., consumer electronics) or which may be alphanumeric or other characters not easily understood by humans (e.g., XL333&3&568).

The database schema 500 includes a message type/message data structure 508. The message type/message data structure 508 may logically relate message types to specific messages. The message types may be represented by message type identifiers. The message type identifiers may be the same as those used in the subject/message type data structure 506, and thus serve as a key or pointer, as indicated by arrow 509. The messages may take a variety of forms, including informational messages, warnings, or advertisements. The messages may be suitable for transmission via the network, for example as part of a Web page, as part of a forum or in streaming form. The messages may take the form of audio messages, video messages, or multi-media messages. The messages may be represented by a message identifier. The message identifier may take a variety of forms. The message identifiers may, for example, take the form of a logical address of a message file as stored on a computer-readable medium, or a pointer to such a logical address. The logical address may, for example, take the form of a Uniform Resource Locator (URL) or Internet Protocol (IP) address that retrieves the message file when entered into a browser executing on a networked computer. The message files may be stored in a database on a computer-readable storage medium controlled by an entity that controls the subject based communication facilitation system. Alternatively, or additionally, messages may be stored in a database on a computer-readable storage medium controlled by an entity other than the entity that controls the subject based communication facilitation system. Thus, the subject based communication facilitation system may use a determined subject of a file requested by the user to determine the types of messages that may be of most interest to a client, and may then determine specific messages to send to the client based on the determined type of message. Such may be done on a file request-by-file request basis, rather than being based on a history of previous file requests, commonly referred to as a browsing history.

Optionally, the database schema 500 includes a client/browsing history data structure 510. The client/browsing history data structure 510 logically relates clients to previous requests for files. The client may be identified by a client identifier. The client identifier may take a variety of forms which may identify a client computing system (e.g., IP address) or a specific user of a client computing system (e.g., user identifier). While denominated as browsing history which is commonly associated with requests for Web pages, the browsing history information may represent any previous requests for files, and may, or may not, include requests for Web pages. Such may be derived from, or take the form of, information stored on a client computing system, for example stored as a “cookie” on a computer-readable medium of the client computing system. Such may allow messages, for example advertisements, to be more specifically tailored to the interests of a given client.

Optionally, the database schema 500 includes a client/message type data structure 512. The client/message type data structure 512 logically relates clients to message types. The client may be identified by a client identifier. The client identifiers may be the same as those used in the client/browsing history data structure 510, and thus serve as a key or pointer, as indicated by arrow 511. The message types may be represented by message type identifiers. The message type identifiers may be the same as those used in the message type/message data structure 508, and thus serve as a key or pointer, as indicated by arrow 513. Thus, the subject based communication facilitation system may use previous requests for files by a client to determine the types of messages that may be of most interest to a client, and may then determine specific messages to send to the client based on the determined type of message. This may be in combination with determining messages based on a determined subject of a file requested by the user, or may be in addition to, in place of such.

Operation of an exemplary embodiment of a subject based communication facilitation system will now be described in greater detail. While reference is made throughout the following discuss to the embodiments of FIGS. 1 and 2, the methods may be employed with the other described embodiments, as well as even other embodiments, with or without modification.

At a high level, a suitable database schema may employ three core tables—Discussion table, Keyword table and Message table. The Discussion table may include a Discussion Identifier, a subject and other supporting information such as username, date, etc. The Keyword table may include the Discussion Identifier, keywords (i.e., keys), keyword weights, and other supporting information. The Message table may include the Discussion Identifier, a Message identifier, a Message body, and other supporting information such as username, date, etc.

FIG. 5B shows a database schema 550 which may be employed in various embodiments of the subject based communication facilitation system, according to another illustrated embodiment.

The database schema 550 may include a Discussion table 552 which may contain the following information for each Discussion (i.e., Forum): Discussion Identifier 554, user submitted subject body 556, IP address 558 from the host the Discussion was posted from, Web page URL 560 that the Discussion was posted against, identifier 562 of the files that the Web page is composed of (see File table), user identifier 564 that identifies a user who created the Discussion, time 566 the Discussion was created, the number of Messages 568 in the Discussion, the rolled up rating 570 of the Discussion (taken from the individual ratings of the Messages) and the keywords (i.e., keys) 572 identifying the subject. Each keyword (i.e., key) 572 may also contain a weight which identifiers a relative importance of the keyword. For example, ten keywords may be used to identify the Web page subject, but a lesser or a greater number of keywords may likewise be suitable.

The Message table 574 may contain the following information for each Message: Message identifier 575, user submitted Message body 576, user identifier 577 that identifiers a user who created the Message, time 578 the Message was created, Discussion Identifier 579 that identifies the Message or forum to which the Message is connected, IP address 580 from the host that posted the Message, Web page URL 581 that the Message was posted against and a community-based rating 582 of the Message.

A User table 584 which contains the following information for each user: User Identifier 585, display name 586, email address 587, account name 588, password 589 and user rating 590. The user rating 590 may be based on how others rate the given user's Messages, as well as how frequently the user posts messages to the forum.

The File table 594 which contains either references to the source file data or the source file data itself 596, for all Web pages 598 that Discussions were created against. This file data consists of the HTML, the CSS (style sheets), etc.—basically whatever is needed to recompose the Web page.

The various tables may of course include a variety of other fields to specify other useful information.

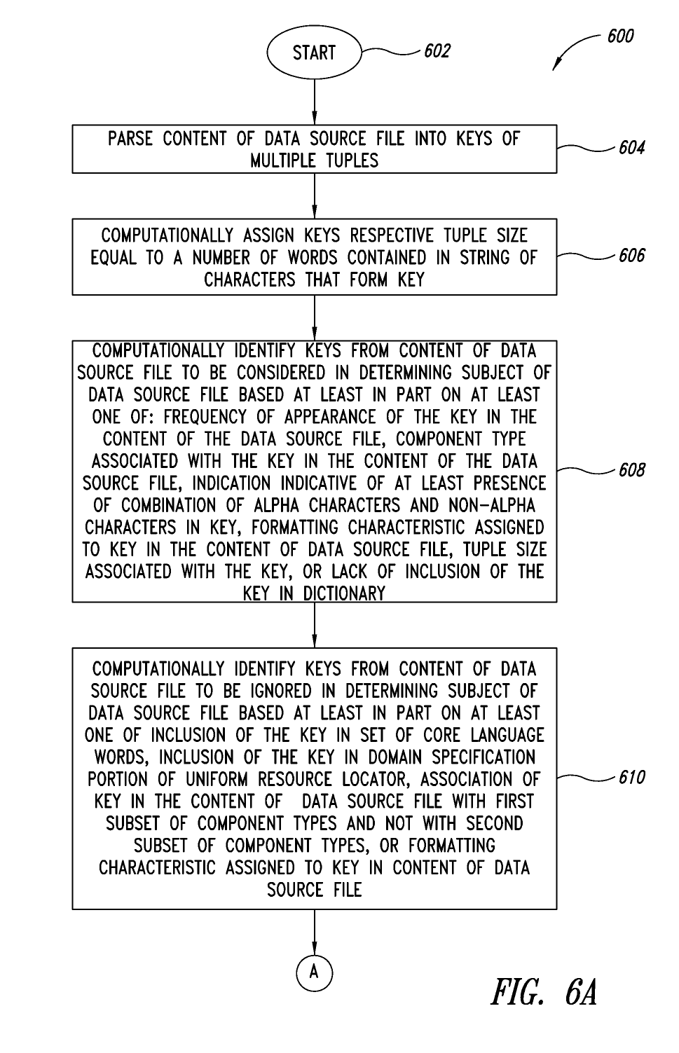

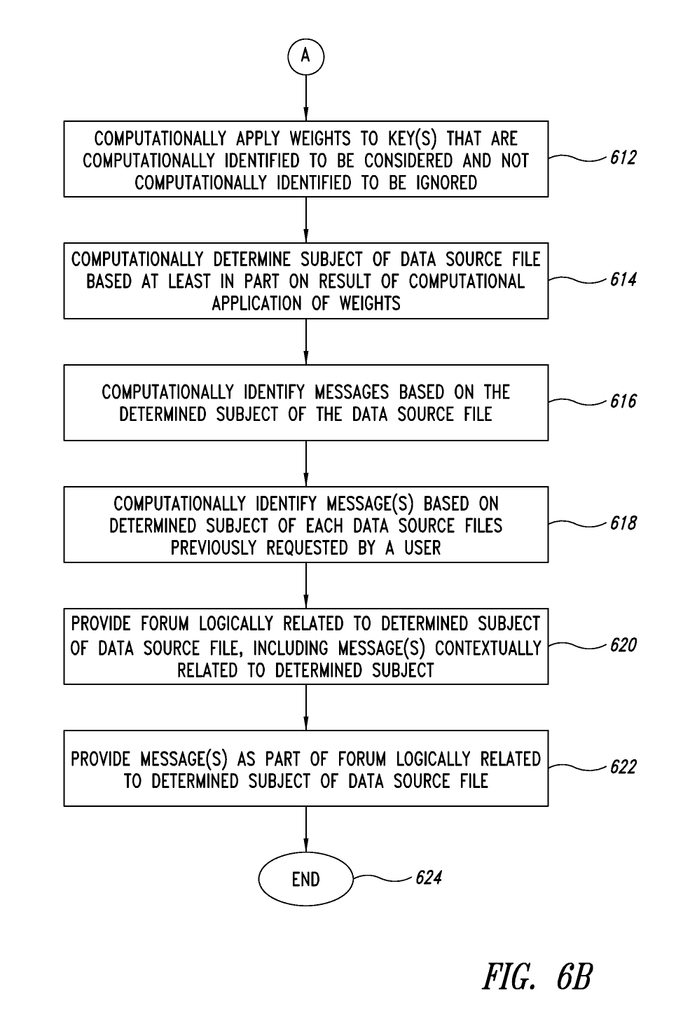

FIGS. 6A and 6B show a method 600 of interacting with data source files stored on computer-readable media and identified by logical addresses, according to one illustrated embodiment.

As an overview of the method 600, relevant information related to a file (e.g., Web page) is collected for analysis. This information may, for example, include the raw Web page content including images, formatting information (e.g., both HTML-based as well as Cascading Style Sheets or CSS information) and/or supplementary information (e.g., logical address such as a URL). The collected information is processed using three core types of algorithms—suggestion algorithms, elimination algorithms and weighting algorithms to determine the subject of a file, for example the subject of a Web page. In one embodiment, an initial high-level algorithm serially executes the sub-algorithms of each of the core algorithms. Other embodiments may execute the sub-algorithms in a different order or concurrently.

A first set of sub-algorithms may be classed as key suggestion algorithms. These sub-algorithms build an initial set of keys by recommending key candidates using algorithm dependent analysis of preprocessed source data file content (e.g., pre-processed HTML and CSS), raw source data file content (e.g., HTML), and supplementary data, for example a logical address of the file (e.g., URL). These suggestion sub-algorithms may suggest keys based on frequency of appearance of a key in the content (e.g., raw content and/or content as displayed to an end user). The most frequently occurring keys from a Web page are typically good candidates for determining the subject of the Web page. These suggestion sub-algorithms may suggest keys from HTML title tags, for instance recommending keys from an HTML page title tag. These suggestion sub-algorithms may suggest keys from an HTML meta elements tag, for example recommending keys from the HTML meta elements “keywords” and “description” tags. These suggestion sub-algorithms may suggest “interesting looking” key, for example keys that are actually a combination of letters, numbers, and or punctuation or non-alphabetic symbols. Such keys are typically used as product model numbers and/or inventory numbers for cataloguing systems, hence may be particular relevant to the subject of the file (e.g., Web page). These suggestion sub-algorithms may suggest keywords that do not appear in a dictionary, for example a standard dictionary of the English language or technical dictionary. If any of the words or sub-strings in the n-tuple key are not in the standard dictionary, than the key is typically a good candidate for determining the subject of the file.

For example, such may find newly “created” keys, strings or “words”, most likely unique creations within the file, for instance unique product names. These suggestion sub-algorithms may suggest keys based on style, for example based on a heading level, a font size, a bold, italic or underline style, a color, and/or a “visibilty state” of the keys or strings in the content of the file. Keys or strings that have been formatted differently from other keys or strings are typically good candidates for determining the subject of the file. These suggestion sub-algorithms may suggest keys based on a presence of the key in the HTML ALT tag. The HTML ALT tag is an alternative text description for images on a Web page, so there is a good chance that such a tag will contain interesting key candidates. These suggestion sub-algorithms may suggest keys based on a number of words in the n-tuple key. If the n-tuple key contains two or more words, than the key is typically a good candidate for determining the subject of the file.

A second set of sub-algorithms may be classed as elimination sub-algorithms. These elimination sub-algorithms may remove key candidates using algorithm-dependent analysis of preprocessed files (e.g., preprocessed HTML), raw content of the files (e.g., HTML), and/or supplementary data, for example a logical address of the file (e.g., URL). From a working list keys, keys are eliminated using various sub-algorithms. For example, the elimination sub-algorithms may eliminate keys that are core language words (e.g., words like “the”, “it”, “she” etc.). These elimination sub-algorithms may eliminate words that appear in a defined portion of a logical address, for example in a domain portion a URL. Keys or strings from the domain portion of a URL tend to occur across the domain often, and thus are not useful for uniquely identifying any given Web page of that domain. For example, “scrapboy” appears throughout the www.scrapboy.com site, so it is not a useful key for identifying Web pages within the scrapboy Website. These elimination sub-algorithms may eliminate keys by source. For instance, the elimination sub-algorithm may eliminate keys which appear only in a title, or appear only in one meta element. The “keywords” meta element is used to help index a web page by Web crawlers, but often contains both good keys or strings and irrelevant keys or strings. This sub-algorithm may remove the irrelevant ones. These elimination sub-algorithms may eliminate keys based on style. For example, the elimination sub-algorithm may eliminate keys or strings that are not rendered on the Web page because a style sheet marks the keys or strings as not visible by default or because a text color is the same as a background color. Marking the keys or strings as not visible is often used for content, like menus, that is not made visible until some user action on the Web page.

A third set of sub-algorithms may be classed as weighting sub-algorithms. These weighting sub-algorithms may recommend a weight (i.e., relative importance) for each key in a working list of keys, using algorithm-dependent analysis of candidate keys in the context of the preprocessed file content (e.g., preprocessed HTML), raw file content (e.g., HTML), and/or supplementary data, for example an address (e.g., URL). These weighting sub-algorithms may weight keys by frequency, for example assigning a weight based upon count of the times the key appears in the file. For instance, keys that appear more often receive a higher weight than those that appear less often. These weighting sub-algorithms may weight keys by source, for example assigning a higher weight to keys that appear in multiple sources. For instance, a key that appears in a title, meta elements, and in the content may receive a higher weight than a key that appears only the content of the file. These weighting sub-algorithms may weight keys based on appearance in a portion of a logical address. For example, keys that appear in a non-domain portion of a URL may be weighted higher than keys that do not appear in the non-domain portion. For instance, in the URL http://www.scrapboy.com/en/videos/, if the 1-tuple “videos” was identified, it would receive a relatively high weight as compared to other keys that do not appear in the domain portion. These weighting sub-algorithms may weight keys by style, for example assigning a higher weight to keys with a specific style. For instance, keys identified to display at or above a threshold font (e.g., large font size) and/or at or above a threshold weight may be weighted relatively high relative to other keys. The font size and/or weight may be set by a heading level assigned to the key. Additionally or alternatively, a position on the Web page may be weighted. Thus, for example keys that appear relatively toward a top of a Web page may be weighted more than keys that appear in other positions since most Web pages tend to put more important information “above the fold” so the important content may be considered or viewed without an scrolling or paging downward.

Each weighting sub-algorithm can also have an assigned weighting factor. This allows for a specific weighting sub-algorithm to contribute more to the overall weight of a key. For example, the sub-algorithm that assigns weights based on frequency of appearance of the key may be assigned more weight than the sub-algorithm that assigns weight based on a source of the key, or vice versa. In one embodiment, the summing of the various weights (roll-up algorithm) is linear (i.e., each weighting sub-algorithm has the same weight factor). However, future algorithms may employ a non-linear contribution model to further differentiate the contribution of individual weighting sub-algorithms. This may cause an sub-algorithm or factor deemed more important or more predictive of subject to exert a stronger influence on the final weighted result that is accumulated across all weighting sub-algorithms for a specific key in contrast to other sub-algorithms or factors that are considered less predictive of the subject.

While generally illustrated as described as a sequential execution of suggestion, elimination and weighting, the various acts may be performed in a different order or sequence, or may include additional acts or eliminate some acts. For example, some acts of the elimination or weighting sub-algorithms may be executed before some acts of the suggestion sub-algorithms. Some acts of the weighting sub-algorithm may be executed before some acts of the elimination sub-algorithms. Some acts of the suggestion, elimination and/or weighting sub-algorithms may be executed concurrently, for example using two or more processors or one or more multi-threaded processors.

The method 600 starts at 602. For example, the method 600 may start in response to receipt of an indication that a request for a file has been sent by a client computing system or client device, or that a request for a file has been received by a server computing system. Alternatively, the method 600 may start independent of any request, for example surveying a network and determining the subject of various files in anticipation of requests for the files being made or received.

At 604, the subject based communication facilitation server computing system parses a content of a data source file into keys of multiple tuples. For example, the subject based communication facilitation server computing system may parse the raw content of the file into strings of characters. The strings may be alpha characters, for example forming recognizable words, or may be strings consisting of or including non-alpha characters (e.g., numerals or special symbols), for example product codes. These strings serve as keys for analyzing the content of the file to determine a subject of the file.

At 606, the subject based communication facilitation server computing system computationally assigns the keys a respective tuple size. Thus, the subject based communication facilitation server computing system may group contiguous strings together to form a key of a higher tuple. The tuple size is equal to a number of words contained in a string of characters that form a key. A tuple is a sequence of words that together represent a single concept. A string containing a single word is a 1-tuple, a string with two words a 2-tuple, and a string with a number n of words an n-tuple. N-tuple analysis detects repeated word sequences that can be treated as a “single word”. For instance, if a word pair such as “Harry Potter” appears multiple times in the content of the file, the word pair is recognized as a single 2-tuple key or string. The individual words “Harry” and “Potter” may also be recognized as separate 1-tupe keys or strings. Alternatively, the individual words “Harry” and “Potter” may be ignored once the subject based communication facilitation server computing system recognizes that the individual words can be combined to form key or string of a higher order tuple. Typically, keys or strings of a higher order tuples tend to be more indicative of subject than keys or strings of a lower order of tuples.

At 608, the subject based communication facilitation server computing system computationally identifies a number of keys from a content of a data source file to be considered in determining a subject of the data source file. The process may be executed by a processor as set of algorithms which may be denominated as a set of suggestion sub-algorithms. The subject based communication facilitation server computing system may determine such based at least in part on at least one of a first number of criteria. The first number of criteria may, for example, include: a frequency of appearance of the key in the content of the data source file, a component type associated with the key in the content of the data source file, an indication indicative of at least a presence of a combination of alpha characters and non-alpha characters in the key, a formatting characteristic assigned to the key in the content of the data source file, a tuple size associated with the key, or a lack of inclusion of the key in a dictionary.

At 610, the subject based communication facilitation server computing system computationally identifies a number of keys from the content of the data source file to be ignored in determining the subject of the data source file. The process may be executed by a processor as a set of algorithms which may be denominated as a set of elimination sub-algorithms. The subject based communication facilitation server computing system may determine such based at least in part on at least one of a second number of criteria. The criteria may, for example, include an inclusion of the key in set of core language words, an inclusion of the key in a domain specification portion of a uniform resource locator, an association of the key in the content of the data source file with a first subset of component types and not with a second subset of component types, or a formatting characteristic assigned to the key in the content of the data source file.

At 612, the subject based communication facilitation server computing system computationally applies weights to at least some of the keys that are computationally identified to be considered and not computationally identified to be ignored. The process may be executed by a processor as a set of algorithms which may be denominated as weighting sub-algorithms.

For instance, each weighting sub-algorithm may derive a component weight score between 0˜1.0. The details of each component weight derivation are unique for each sub-algorithm. In fact, some sub-algorithms may utilize the component weights of other sub-algorithms in their calculations.

At 614, the subject based communication facilitation server computing system computationally determines the subject of the data source file based at least in part on a result of computationally applying the weights. Such may include tallying or otherwise determining a total weight for the keys. As noted above, not only can individual weighting sub-algorithms assign weights to keys based on specific factors or characteristics, but the specific weighting sub-algorithms themselves may be assigned relative weights, for example based on the predictive nature of the particular weighting sub-algorithm. Such may be accounted for in determining the subject. For example, the weight assigned to a key by a given weighting sub-algorithm may be multiplied by a weight assigned to the given weighting sub-algorithm.

Optionally at 616, the subject based communication facilitation server computing system computationally identifies messages based on the determined subject of the data source file. The subject based communication facilitation server computing system may employ a data structure such as a table or record to logically associate subjects with certain types of messages. For example, where the subject is a particular type of consumer electronics, the subject based communication facilitation server computing system may logically associate the subject with other products of the same type of consumer electronics (e.g., other brands of cameras) or with other types of consumer electronics (digital cameras logically associated with camcorders, DVD players and/or televisions). Where the subject is a musical record or compact disc, the subject based communication facilitation server computing system may logically associate the subject with other records or compact discs form the same artist, same genre or with other forms of entertainment (e.g., DVDs). Messages related to the subject of the data source file (e.g., Web page) may be delivered first, and other messages may optionally follow. A subject relaxation feature option may allow looser constraints to be applied (e.g., same manufacturer, similar artist, etc.). The subject based communication facilitation server computing system may than identify particular messages based on the determined message type. For example, the subject based communication facilitation server computing system may employ a data structure that logically associates particular messages (e.g., advertisements) with particular message types. Thus, a set of advertisements may be designated to be delivered on occurrence of a request for a file that pertains to a particular subject. For example, one or more advertisements for computers may be delivered in response to a request for a Web page that relates to new models of computers. Advertisements for cars may be delivered in response to a request for a Web page that relates to cars (e.g., sale of new cars, parts, repair services, etc.).

The default mode is to only show forums that are an exact match with the subject to the current web page. However, as noted above a “subject relaxation” feature option may also be provided. Such may provide an end-user with a control through which they can relax the page subject matching. Such may, for example, be used to show forums that are less rigidly connected to the subject of the current Web page. The subject relaxation feature works by creating a “match indicator” for each forum that reflects how well the keys associated with a particular forum match the subject of the current Web page. The match indicator is calculated by comparing the keys for the current Web page and the forum. The strongest keys (i.e., highest weighted) are first compared; if they match, then a high contribution is added to the match indicator. This comparison continues through all of the keys. As the strength of the keys decrease, the contribution to the match indicator lessens. Such may be a non-linear relationship. In this fashion, the keys with a higher weighting exert a greater influence on the overall match indicator. The end-user can use the “relaxation” control to show forums that have a lower score on the match indicator than would otherwise be employed.

Optionally at 618, the subject based communication facilitation server computing system computationally identifies message(s) based on determined subject of each data source files previously requested by a user. The subject based communication facilitation server computing system may, for example, employ a browsing history of files (e.g., Web pages) previously requested by the client computing system or device, or even by a specific user of such client computing system or device. The subject based communication facilitation server computing system may employ cookies or other files on the client computing system or device to track such information, or may receive such information from a server computing system that serves the files. Alternatively, the subject based communication facilitation server computing system may keep track of such information itself, although such may be more cumbersome to manage.

Optionally, at 620, the subject based communication facilitation server computing system provides a forum logically related to determined subject of data source file. The subject based communication facilitation server computing system may determine one or more appropriate forums based on the determined subject of the requested file. The subject based communication facilitation server computing system may employ one or more data structures (e.g., tables, records, etc.) to determines the appropriate forum. Thus, for example, the subject based communication facilitation server computing system may provide a forum related to a particular product, type of product, manufacture of the product in response to a request for a file which has the particular product as its subject. Also for example, the subject based communication facilitation server computing system may provide a forum related to a particular activity in response to a request for a file, such as a Web page, related to the particular activity or a group involved in the particular activity. Providing the forum may include pushing content of forum to the client computing system or client device that requested the file, or may include pushing a logical address or a link to the client computing system or client device that requested the file. Such may be sent such that the forum is displayed within a presentation or window of a browser executing on the client computing system or client device that requested the file. Alternatively, show may be sent such that the forum is displayed in a separate window from the browser.

At 622, the subject based communication facilitation server computing system provides message(s) logically related to determined subject of data source file. As illustrated, the subject based communication facilitation server computing system forum may provide message(s) contextually related to determined subject as part of providing the forum. Alternatively, the subject based communication facilitation server computing system may provide such messages separately from the forum. The subject based communication facilitation server computing system may provide messages identified based on the subject of the requested file, the files previously requested by the client computing system or client device or a combination of both. Providing the messages may include pushing the content of the messages to the client computing system or client device that requested the file, or may include pushing a logical address or a link to the client computing system or client device that requested the file. Such may be sent such that the messages are is displayed within a presentation or window of a browser executing on the client computing system or client device that requested the file or as part of the forum. Alternatively, such may be sent such that the messages are displayed in a separate window from the browser or the forum.

The method 600 terminates at 624. The method 600 may terminate, for example, in completion of sending information to the client computing system or client device. Alternatively, the method 600 may repeat for example returning to 604. In some embodiments, the method 600 may be executed as a multi-threaded processor, or may be executed as separate threads on one or more processors.

FIG. 7 shows a method 700 of computationally identifying keys, according to one illustrated embodiment. The method 700 may be useful in performing identification of keys 608, 610 of the method 600 (FIGS. 6A and 6B).

At 702, the subject based communication facilitation server computing system computationally identifies string(s) of characters in content of data source file. The subject based communication facilitation server computing system may identify strings of characters, which may consist of only alpha characters or may consist of other characters such a numeric characters or symbol characters.

FIG. 8 shows a method 800 of computationally identifying keys, according to one illustrated embodiment. The method 800 may be useful in performing identification of keys 608, 610 of the method 600 (FIGS. 6A and 6B).

At 802, the subject based communication facilitation server computing system computationally identifies string(s) of characters in content of Webpage source file. Thus, the subject based communication facilitation server computing system may operate on markup language based files such as HTML or XML files. The subject based communication facilitation server computing system may identify strings of characters in the content of such files. The strings may consist of only alpha characters or may consist of other characters such a numeric characters or symbol characters.

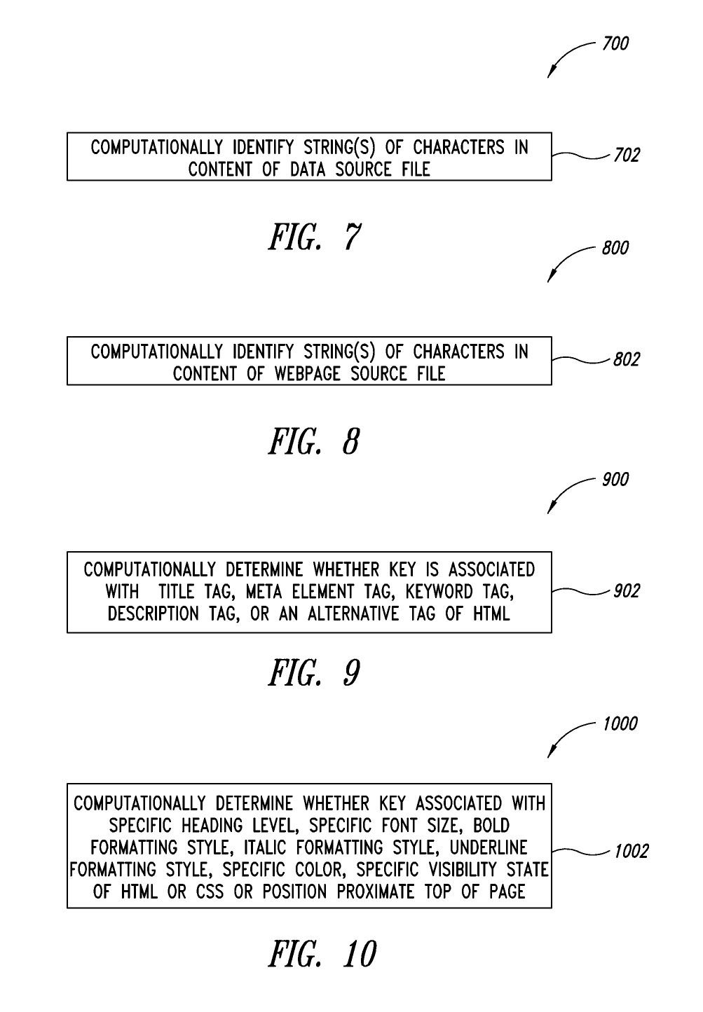

FIG. 9 shows a method 900 of computationally identifying a number of keys from a content of a data source file to be considered in determining a subject of the data source file based at least in part on a component type associated with the key in the content of the data source file, according to one illustrated embodiment. The method 900 may be useful in performing identification of keys 608, 610 of the method 600 (FIGS. 6A and 6B).

At 902, the subject based communication facilitation server computing system computationally determines whether a key is associated with at least one of a title tag, a meta element tag, a keyword tag, a description tag, or an alternative tag of HTML. For example, the subject based communication facilitation server computing system may identify any strings of characters in an HTML file which are tagged with either a title tag, a meta element tag, a keyword tag, a description tag or an alternative tag.

FIG. 10 shows a method 1000 of computationally identifying a number of keys from a content of a data source file to be considered in determining a subject of the data source file based at least in part on a formatting characteristic assigned to the key in the content of the data source file, according to one illustrated embodiment. The method 1000 may be useful in performing identification of keys 608 of the method 600 (FIGS. 6A and 6B).

At 1002, the subject based communication facilitation server computing system computationally determines whether a key associated with at least one of a specific heading level, a specific font size, a bold formatting style, an italic formatting style, an underline formatting style, a specific color, or a specific visibility state of HTML or CSS. For example, the subject based communication facilitation server computing system may identify strings of characters in an HTML or CSS file which are associated with either a specific heading level, a specific font size, a bold formatting style, an italic formatting style, an underline formatting style, a specific color, or a specific visibility state.

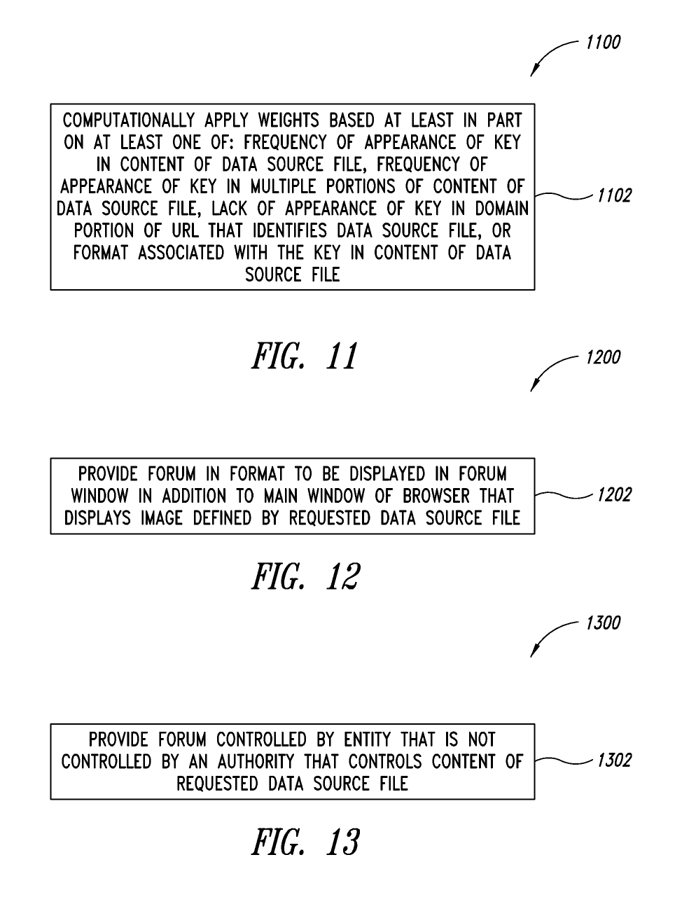

FIG. 11 shows a method 1100 of computationally applying weights to at least some of the keys that are computationally identified to be considered and not computationally identified to be ignored, according to one illustrated embodiment. The method 1100 may be useful performing 612 of the method 600 (FIGS. 6A and 6B).

At 1102, the subject based communication facilitation server computing system computationally applies weights based at least in part on at least one of: frequency of appearance of key in content of data source file, frequency of appearance of key in multiple portions of content of data source file, appearance of key in a non-domain portion of URL that identifies data source file, or format associated with the key in content of data source, proximity to top portion of a Web page. For example, the subject based communication facilitation server computing system applies a defined weight to a key based on the key satisfying any of the above criteria. Alternatively, the subject based communication facilitation server computing system may assign a weight to the key based on each of the above criteria that the key satisfies. Thus, the weights may be cumulative, the more conditions satisfied the higher the weight. Such may or may not be linear (i.e., the same weight for each of the criteria.)

FIG. 12 shows a method 1200 of providing a forum, according to one illustrated embodiment. The method 1200 may be useful performing 620 of the method 600 (FIGS. 6A and 6B).

At 1202, the subject based communication facilitation server computing system provides a forum in a format to be displayed in a forum window in addition to a main window of a browser that displays an image defined by a requested data source file.

FIG. 13 shows a method 1300 providing a forum, according to one illustrated embodiment. The method 1300 may be useful in performing 620 of the method 600 (FIGS. 6A and 6B).

At 1302, provide a forum controlled by an entity that is not controlled by an authority that controls the content of a requested data source file. Thus, the subject based communication facilitation server computing system may control the forum or some other entity. Independence allows users to trust that the forum is not unduly influenced by those who may have a financial or other motivate.

FIG. 14 shows a method 1400 of providing a forum, according to one illustrated embodiment. The method 1400 may be useful in performing 620 of the method 600 (FIGS. 6A and 6B).

At 1402, the subject based communication facilitation server computing system logically associates data source files with a single forum where each of the data source files of the plurality of data source files have a respective determined subject in common. Thus, were multiple files, for instance multiple Web pages, share a common subject, clients that request those files are directed or provided with the same forum(s).

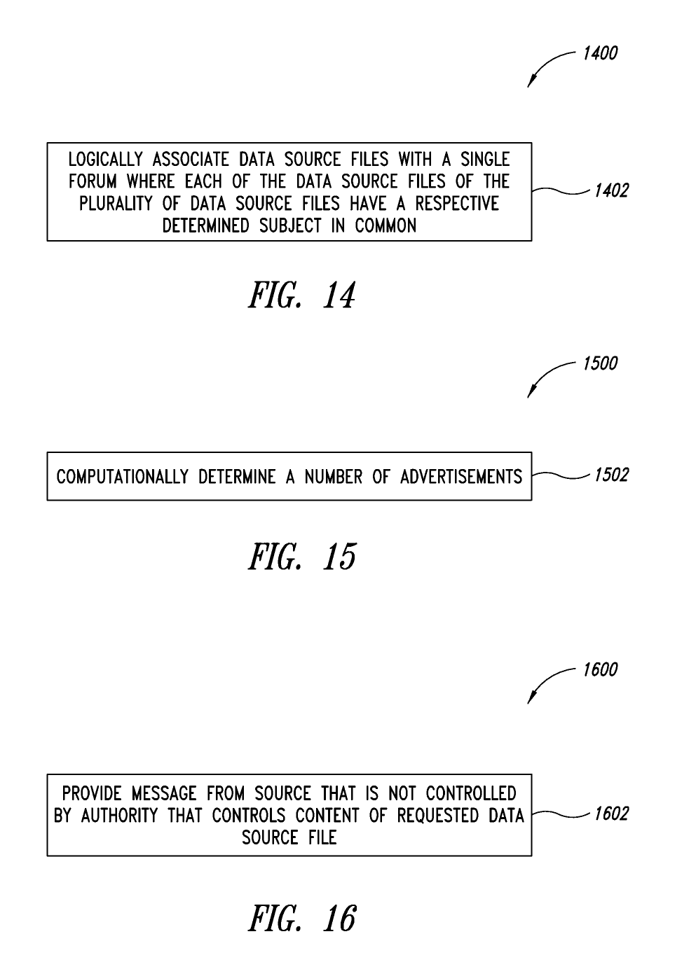

FIG. 15 shows a method 1500 of identifying messages based on the determined subject of the data source file, according to one illustrated embodiment. The method 1500 may be useful in performing 616 of the method 600 (FIGS. 6A and 6B).

At 1502, the subject based communication facilitation server computing system computationally determines a number of advertisements. In some embodiments, the messages take the form of advertisements. The subject based communication facilitation server computing system may determine or select one or more advertisements based on the subject of the requested file. As noted above, the subject may be logically related to a message type, which may be logically related to particular messages, such as advertisements.

FIG. 16 shows a method 1600 of identifying messages based on the determined subject of the data source file, according to one illustrated embodiment. The method 1600 may be useful in performing 616 of the method 600 (FIGS. 6A and 6B).

At 1602, the subject based communication facilitation server computing system provides message from source that is not controlled by authority that controls content of requested data source file. Providing messages independent of control by an entity that has a financial or other interest in the subject may be useful in establishing trust with users or clients.

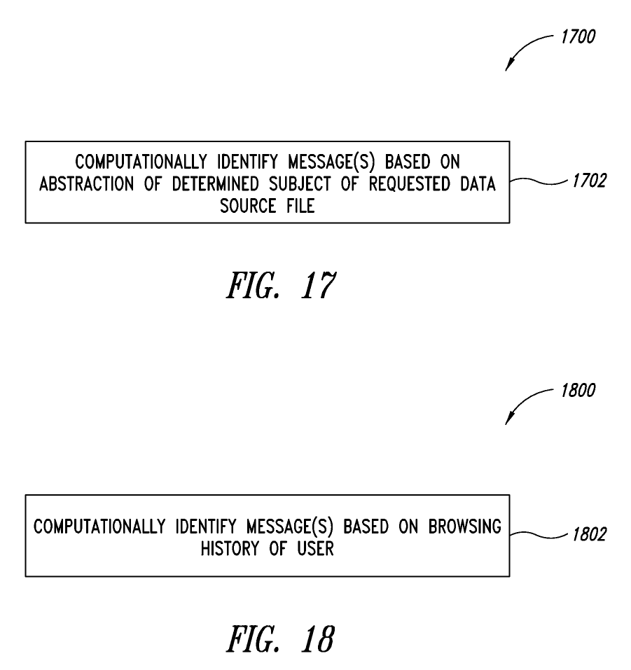

FIG. 17 shows a method 1700 of identifying messages, according to one illustrated embodiment. The method 1700 may be useful in performing 616 and/or 618 of the method 600 (FIGS. 6A and 6B).

At 1702, the subject based communication facilitation server computing system computationally identifies message(s) based on abstraction of determined subject of requested data source file. The subject based communication facilitation server computing system may perform an abstraction on the determined subject matter, either abstracting to a higher level or a lower level. For example, where a subject is determined to be a particular camera, subject based communication facilitation server computing system may abstract to the higher levels of digital cameras, cameras or consumer electronics. Alternatively, where a subject is determined to be a certain make of cameras, the subject based communication facilitation server computing system may abstract down to specific models of cameras.

FIG. 18 shows a method 1800 of identifying messages based on previous requests, according to one illustrated embodiment. The method 1800 may be useful performing 618 of the method 600 (FIGS. 6A and 6B).

At 1802, the subject based communication facilitation server computing system computationally identifies message(s) based on browsing history of user. The subject based communication facilitation server computing system may rely on a history of previously requested files, for example previously requested Web pages, to determine an appropriate set of messages. For example, the subject based communication facilitation server computing system may use the subjects of each of a number of previously requested Web pages to determine a corresponding message type and/or message.

In summary, a universal, ubiquitous platform to be used for all discussion forums. Currently, almost every Web page or domain (e.g., www.amazon.com) has its own, proprietary discussion forum. Furthermore, you are required to create and maintain accounts with each specific site which can be tedious and error prone. The approach described herein may provide a single, convenient platform to engage in discussions on any arbitrary Web page on the Internet.

The discussion forum is tied to the specific subject of the Web page and not the URL. This is particularly useful because there are typically many different URLs which ultimately point to the same Web page or content.

Since in at least one embodiment the forum is “community policed” and the discussion forum is not owned or controlled by a Website/Webpage owner, there is no doubt that any and all opinions or comments in the forum will be presented for all to see, read and respond to. This concept is particularly powerful when combined with the ubiquitous nature of the approach—providing a single free speech tool to allow commentary and opinion on any Web page on the Internet. Today, most discussion forums are moderated with the forum owner having the ultimate power to delete listings. In some cases, this moderation is welcomed (e.g., removal of offensive or libelous comments), but in other cases such moderation is not welcomed (e.g., deleting a post indicating that service or products provide by the company moderating the forum is not up to par).

Currently, online advertising on a Web page is typically governed by the Web site owner; so the owner of the Web page can choose which advertising is displayed and which is not. There are also some sites, most notably government Web sites, that do not support any advertising. There is no general advertising channel that is a free market, available for anyone to utilize, in the manner of newspaper, radio, or television). The approached described herein may provide such a general advertising channel, across every Web page on the Internet. Some examples may include Best Buy® associating advertising with a Circuit City® Web page, or immigration lawyers associating advertising with the US government's immigration related Web pages.

Given the approach described herein, the following may all be known: (a) the subject of the current Web page or other file, (b) a browsing history of a user, and (c) the subject of each of the previously viewed web pages or other files. With this information, the platform can provide specific, relevant and focused advertising to the end user. The end user may even look on the advertising positively since the advertising will be so relevant to what the end user is currently viewing or recently viewed.

In some embodiments, identification and/or analysis of keys and identification of subjects may be executed on a client computer system or other end user device, while forums and messages may be provided from a server computer system. In other embodiments, identification and/or analysis of keys and/or identification of subjects may be executed on the server computer system.

Other variations in which machines perform the various acts are possible.

Analysis of a Web page or other file to determine keys such as keywords which can uniquely identify the Web page and distinguish such from the multitude of other Web pages within a domain (e.g., www.amazon.com) or uniquely identify other files greatly facilitates the tying of comments to the subject of a Web page or other file. There is also a possibility that Web pages may be uniquely identified across the entire Internet.

It is quite common for the storage location of files, for example, Web pages to be reorganized. Such may, for example, cause the same or very similar Web page to be identified by a different URL. Such reorganization could range from significant (e.g., reorganize from a www.estore.com\products to www.estore.com\cameras, www.estore.com\mp3players, www.estore.com\kitchen, etc.) to minor (e.g., reorganize from www.estore.com\camera to www.estore.com\cameras). Tying the discussion forums to the subject of the Web page ensures that the discussion forums are not orphaned as a result of such a reorganization.

It is also quite common for Web pages to go through routine maintenance, for instance—rebrand the Web page (e.g., change cosmetic appearance such as company banners, company images, etc.), reorganize the flow of information on the Web page (e.g., move the product details lower on the page, change the product image, etc.). The subject determination algorithms are designed to withstand a certain threshold of changes to the Web page. This makes it less likely that the discussion forums will be orphaned as a result of such routine maintenance of Web pages.

Some embodiments may include analysis of files, such as Web pages, as the amount of data within the Wukii system increases. For example, once a number of entries within a specific domain (i.e., forums attached to Web pages within the domain) are identified, all the Web pages within the domain may be analyzed to determine if additional optimizations may be made. For instance, after a detailed analysis of the keys for every Web page in a given domain (e.g., AMAZON.COM, TARGET.COM domains), the system may determine that the key “lowest prices” occurs on every Web page in the given domain. If such is the case, that key may be add as a new elimination algorithm that specifically eliminates the key “lowest prices” from the weighting or subject identification of any Web page in the given domain (e.g., only in the AMAZON.COM or TARGET.COM domains).

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary subject based communication facilitation server computing system generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method of interacting with data source files stored on computer-readable media and identified by logical addresses, the method comprising:
computationally identifying a number of keys from a content of a data source file to be considered in determining a subject of the data source file based at least in part on at least one of: a frequency of appearance of the key in the content of the data source file, a component type associated with the key in the content of the data source file, an indication indicative of at least a presence of a combination of alpha characters and non-alpha characters in the key, a formatting characteristic assigned to the key in the content of the data source file, a tuple size associated with the key, or a lack of inclusion of the key in a dictionary;
computationally identifying a number of keys from the content of the data source file to be ignored in determining the subject of the data source file based at least in part on at least one of an inclusion of the key in set of core language words, an inclusion of the key in a domain specification portion of a uniform resource locator, an association of the key in the content of the data source file with a first subset of component types and not with a second subset of component types, or a formatting characteristic assigned to the key in the content of the data source file;
computationally applying weights to at least some of the keys that are computationally identified to be considered and not computationally identified to be ignored; and
computationally determining the subject of the data source file based at least in part on a result of computationally applying the weights.

2. The method of claim 1, further comprising:
parsing the content of the data source file into a plurality of keys before identifying the number of keys to either be considered or ignored in determining the subject of the data source file.

3. The method of claim 1, further comprising:
parsing the content of the data source file into a plurality of keys of multiple tuples before identifying the number of keys to either be considered or ignored in determining the subject of the data source file; and
computationally assigning each of the keys a respective tuple size equal to a number of words contained in a string of characters that form the key.

4. The method of claim 1 wherein computationally identifying a number of keys from a content of a data source file to be considered in determining a subject of the data source file includes computationally identifying a number of strings of characters in the content of the data source file.

5. The method of claim 1 wherein computationally identifying a number of keys from a content of a data source file to be considered in determining a subject of the data source file includes computationally identifying a number of strings of characters in the content of a Webpage source file.

6. The method of claim 1 wherein computationally identifying a number of keys from a content of a data source file to be considered in determining a subject of the data source file based at least in part on a component type associated with the key in the content of the data source file includes computationally determining whether the key is associated with a title tag, a meta element tag, a keyword tag, a description tag, or an alternative tag of a Hypertext Markup Language (HTML).

7. The method of claim 1 wherein computationally identifying a number of keys from a content of a data source file to be considered in determining a subject of the data source file based at least in part on a formatting characteristic assigned to the key in the content of the data source file includes computationally determining whether the key is associated with a specific heading level, a specific font size, a bold formatting style, an italic formatting style, an underline formatting style, a specific color, or a specific visibility state of a Hypertext Markup Language (HTML) or Cascading Style Sheet.

8. The method of claim 1 wherein computationally applying weights to at least some of the keys that are computationally identified to be considered and not computationally identified to be ignored includes computationally applying weights based at least in part on at least one of: a frequency of appearance of the key in the content of the data source file, a frequency of appearance of the key in multiple portions of the content of the data source file, a lack of appearance of the key in a domain portion of a uniform resource locator that identifies the data source file, an appearance of the key in a portion of the uniform resource locator other than the domain portion, a position of the key in the data source file, or a format associated with the key in the content of the data source file.

9. The method of claim 1, further comprising:
in response to a request for a particular data source file, providing a forum logically related to the determined subject of the data source file, the forum including a number of messages contextually related to the determined subject of the data source.

10. The method of claim 9 wherein providing a forum logically related to the determined subject of the data source file includes providing the forum in a format to be displayed in forum window in addition to a main window of a browser that displays an image defined by the requested data source file.

11. The method of claim 9 wherein providing a forum logically related to a determined subject of the data source file includes providing the forum controlled by an entity that is not controlled by an authority that controls a content of the data source file.

12. The method of claim 1, further comprising:
logically associating a plurality of data source files with a single forum where each of the data source files of the plurality of data source files have a respective determined subject in common.

13. The method of claim 9, further comprising:
computationally identifying a number of messages based on the determined subject of the data source file; and
providing at least one of the messages as part of the forum logically related to the determined subject of the data source file.

14. The method of claim 13 wherein computationally identifying a number of messages based on the determined subject of the data source file includes computationally determining a number of advertisements.

15. The method of claim 13 wherein providing at least one of the messages as part of the forum logically related to the determined subject of the data source file includes providing the at least one message from a source that is not controlled by an authority that controls the content of the data source file.

16. The method of claim 13 wherein computationally identifying a number of messages based on the determined subject of the data source file includes computationally identifying the number of messages based on an abstraction of the determined subject of the data source file.

17. The method of claim 1, further comprising:
computationally identifying a number of messages based on a determined subject of each of a plurality of data source files previously requested by a user; and
providing at least one of the messages as part of the forum logically related to the determined subject of the data source file.

18. The method of claim 1, further comprising:
computationally identifying a number of messages based on a browsing history of a user; and
providing at least one of the messages as part of the forum logically related to the determined subject of the data source file.

19. The method of claim 13 wherein computationally identifying a number of messages based on a determined subject of each of a plurality of data source files previously requested by a user includes computationally identifying the number of messages based on an abstraction of the determined subject of each of a plurality of data source files previously requested by the user.

20. A networked computing system, comprising:
at least one networked computer, including at least one processor and at least one processor-readable storage medium that stores instructions that when executed by the at least one processor causes the at least one processor to associate a number of logical network addresses of a plurality of data source files with a number of logical network addresses of a number of forums based on subject, where some of the data source files are identified by multiple logical network addresses and where a content of some of the data source files identified by a single logical network address differs based on an active content component of the source data file, by:
for each of a number of data source files, computationally identifying a number of keys from the content of the data source file to be considered in determining a subject of the data source file based on a raw content of the data source file, a formatting of the content of the data source file and an organizational aspect of a presentation of the content of the data source file;
computationally identifying a number of keys from the content of the data source file to be ignored in determining the subject of the data source file based on a raw content of the data source file, a formatting of the content of the data source file and an organizational aspect of a presentation of the data source file;
computationally applying weights to at least some of the keys that are computationally identified to be considered and not computationally identified to be ignored; and
computationally determining the subject of the data source file based at least in part on a result of computationally applying the weights.

21. The networked computing system of claim 20 wherein computationally identifying a number of keys from the content of the data source file to be considered in determining a subject of the data source file on a raw content of the data source file, a formatting of the content of the data source file and an organizational aspect of a presentation of the content of the data source file includes computationally identifying a number of keys from the content of the data source file to be considered in determining a subject of the data source file based at least in part on at least one of: a frequency of appearance of the key in the content of the data source file, a component type associated with the key in the content of the data source file, an indication indicative of at least a presence of a combination of alpha characters and non-alpha characters in the key, a formatting characteristic assigned to the key in the content of the data source file, a tuple size associated with the key, or a lack of inclusion of the key in a dictionary.

22. The networked computing system of claim 20 wherein computationally identifying a number of keys from the content of the data source file to be ignored in determining the subject of the data source file based on a raw content of the data source file, a formatting of the content of the data source file, and an organizational aspect of a presentation of the content of the data source file includes computationally identifying the number of keys from the content of the data source file to be ignored in determining the subject of the data source file based at least in part on at least one of an inclusion of the key in set of core language words, an inclusion of the key in a domain specification portion of a uniform resource locator, an association of the key in the content of the data source file with a first subset of component types and not with a second subset of component types, or a formatting characteristic assigned to the key in the content of the data source file.

23. The networked computing system of claim 20 wherein the instructions cause the at least one processor to associate a number of logical network addresses of a plurality of data source files with a number of logical network addresses of a number of forums based on subject, further by:
parsing the content of the data source file into a plurality of keys of multiple tuples before identifying the number of keys to either be considered or ignored in determining the subject of the data source file; and
computationally assigning each of the keys a respective tuple size equal to a number of words contained in a string of characters that form the key.

24. The networked computing system of claim 20 wherein computationally identifying a number of keys from a content of a data source file to be considered in determining a subject of the data source file includes computationally identifying a number of strings of characters in the content of a Webpage source file.

25. The networked computing system of claim 20 wherein computationally identifying a number of keys from a content of a data source file to be considered in determining a subject of the data source file based at least in part on a component type associated with the key in the content of the data source file includes computationally determining whether the key is associated with at least one of a title tag, a meta element tag, a keyword tag, a description tag, or an alternative tag of a Hypertext Markup Language (HTML).

26. The networked computing system of claim 20 wherein computationally identifying a number of keys from a content of a data source file to be considered in determining a subject of the data source file based at least in part on a formatting characteristic assigned to the key in the content of the data source file includes computationally determining whether the key is associated with at least one of a specific heading level, a specific font size, a bold formatting style, an italic formatting style, an underline formatting style, a specific color, or a specific visibility state of a Hypertext Markup Language (HTML) or Cascading Style Sheet.

27. The networked computing system of claim 20 wherein computationally applying weights to at least some of the keys that are computationally identified to be considered and not computationally identified to be ignored includes computationally applying weights based at least in part on at least one of: a frequency of appearance of the key in the content of the data source file, a frequency of appearance of the key in multiple portions of the content of the data source file, a lack of appearance of the key in a domain portion of a uniform resource locator that identifies the data source file, a position of the key in the data source file, or a format associated with the key in the content of the data source file.

28. The networked computing system of claim 20 wherein in response to a request for one of the data source files the instructions cause the at least one processor to provide a forum logically related to the determined subject of the requested one of the data source files, by:
providing the forum which is controlled by an entity that is not controlled by an authority that controls a content of the requested data source file in a format to be displayed in forum window in addition to a main window of a browser that displays an image defined by the requested data source file.

29. The networked computing system of claim 20 wherein in response to a request for one of the data source files the instructions cause the at least one processor to provide at least one message contextually related to the determined subject of the requested one of the data source files, by:
computationally identifying a number of messages based on the determined subject of the data source file; and
providing at least one of the messages as part of the forum logically related to the determined subject of the data source file.

30. The networked computing system of claim 20 wherein in response to a request for one of the data source files the instructions cause the at least one processor to provide at least one advertisement, by:
computationally identifying a number of advertisements based on a determined subject of each of a plurality of data source files previously requested by a user; and
providing at least one of the advertisements as part of the forum logically related to the determined subject of the data source file.

31. The networked computing system of claim 20 wherein the at least one computer system includes at least one client computer system and at least one server computer system remote from the at least one client computer system, the at least one client computer system including at least one processor and at least one processor-readable storage medium that stores browser instructions that when executed by the at least one processor cause the at least one processor to display information, by:
requesting one of the data source files from the at least one server computer system;
displaying a presentation defined by the requested data source file; and
displaying a forum of comments logically associated with the requested data source filed based on the determined subject of the requested data source file.

32. At least one computer-readable medium that stores instructions that when executed by at least one computer system cause the at least one computer system to associate a number of logical network addresses of a plurality of data source files with a number of logical network addresses of a number of forums based on subject matter, where some of the data source files are identified by multiple logical network addresses and where a content of some of the data source files identified by a single logical network address differs based on an active content component of the source data file, by:
for each of a number of data source files, computationally identifying a number of keys from the content of the data source file to be considered in determining a subject of the data source file based on a raw content of the data source file, a formatting of the content of the data source file and an organizational aspect of a presentation of the content of the data source file;
computationally identifying a number of keys from the content of the data source file to be ignored in determining the subject of the data source file based on a raw content of the data source file, a formatting of the content of the data source file and an organizational aspect of a presentation of the data source file;
computationally applying weights to at least some of the keys that are computationally identified to be considered and not computationally identified to be ignored; and
computationally determining the subject of the data source file based at least in part on a result of computationally applying the weights.

33. The at least one computer-readable medium of claim 32 wherein computationally identifying a number of keys from the content of the data source file to be considered in determining a subject of the data source file on a raw content of the data source file, a formatting of the content of the data source file and an organizational aspect of a presentation of the content of the data source file includes computationally identifying a number of keys from the content of the data source file to be considered in determining a subject of the data source file based at least in part on at least one of: a frequency of appearance of the key in the content of the data source file, a component type associated with the key in the content of the data source file, an indication indicative of at least a presence of a combination of alpha characters and non-alpha characters in the key, a formatting characteristic assigned to the key in the content of the data source file, a tuple size associated with the key, or a lack of inclusion of the key in a dictionary.

34. The at least one computer-readable medium of claim 32 wherein computationally identifying a number of keys from the content of the data source file to be ignored in determining the subject of the data source file based on a raw content of the data source file, a formatting of the content of the data source file, and an organizational aspect of a presentation of the content of the data source file includes computationally identifying the number of keys from the content of the data source file to be ignored in determining the subject of the data source file based at least in part on at least one of an inclusion of the key in set of core language words, an inclusion of the key in a domain specification portion of a uniform resource locator, an association of the key in the content of the data source file with a first subset of component types and not with a second subset of component types, or a formatting characteristic assigned to the key in the content of the data source file.

35. The at least one computer-readable medium of claim 32 wherein the instructions cause the at least one processor to associate a number of logical network addresses of a plurality of data source files with a number of logical network addresses of a number of forums based on subject, further by:
parsing the content of the data source file into a plurality of keys of multiple tuples before identifying the number of keys to either be considered or ignored in determining the subject of the data source file; and
computationally assigning each of the keys a respective tuple size equal to a number of words contained in a string of characters that form the key.

36. The at least one computer-readable medium of claim 32 wherein computationally identifying a number of keys from a content of a data source file to be considered in determining a subject of the data source file includes computationally identifying a number of strings of characters in the content of a Webpage source file.

37. The at least one computer-readable medium of claim 32 wherein computationally identifying a number of keys from a content of a data source file to be considered in determining a subject of the data source file based at least in part on a component type associated with the key in the content of the data source file includes computationally determining whether the key is associated with a title tag, a meta element tag, a keyword tag, a description tag, or an alternative tag of a Hypertext Markup Language (HTML).

38. The at least one computer-readable medium of claim 32 wherein computationally identifying a number of keys from a content of a data source file to be considered in determining a subject of the data source file based at least in part on a formatting characteristic assigned to the key in the content of the data source file includes computationally determining whether the key is associated with a specific heading level, a specific font size, a bold formatting style, an underline formatting style, an italic formatting style, a specific color, or a specific visibility state of a Hypertext Markup Language (HTML) or Cascading Style Sheet.

39. The at least one computer-readable medium of claim 32 wherein computationally applying weights to at least some of the keys that are computationally identified to be considered and not computationally identified to be ignored includes computationally applying weights based at least in part on at least one of: a frequency of appearance of the key in the content of the data source file, a frequency of appearance of the key in multiple portions of the content of the data source file, a lack of appearance of the key in a domain portion of a uniform resource locator that identifies the data source file, or a format associated with the key in the content of the data source file.

40. The at least one computer-readable medium of claim 32 wherein in response to a request for one of the data source files the instructions cause the at least one processor to provide a forum logically related to the determined subject of the requested one of the data source files, by:
providing the forum which is controlled by an entity that is not controlled by an authority that controls a content of the requested data source file in a format to be displayed in forum window in addition to a main window of a browser that displays an image defined by the requested data source file.

41. The at least one computer-readable medium of claim 32 wherein in response to a request for one of the data source files the instructions cause the at least one processor to provide at least one message contextually related to the determined subject of the requested one of the data source files, by:
computationally identifying a number of messages based on the determined subject of the data source file; and
providing at least one of the messages as part of the forum logically related to the determined subject of the data source file.

42. The at least one computer-readable medium of claim 32 wherein in response to a request for one of the data source files the instructions cause the at least one processor to provide at least one advertisement, by:
computationally identifying a number of advertisements based on a determined subject of each of a plurality of data source files previously requested by a user; and
providing at least one of the advertisements as part of the forum logically related to the determined subject of the data source file.
